(19) United States
(12) Patent Application Publication
(10) Pub. No.: US 2008/0048513 A1
(43) Pub. Date: Feb. 28, 2008

(54) Multipolar-Plus Machines-Multipolar Machines With Reduced Numbers of Brushes

(76) Inventor: Doris Wilsdorf, Charlottesville, VA (US)

Correspondence Address: Kimberley A Chasteen;Williams Mullen, 721 Lakefront Commons, Suite 200, Newport News, VA, 23606, US

(21) Appl. No.: 11/630,923

(22) PCT Filed: Jun. 29, 2005
(86) PCT No.: PCT/US05/23245

§ 371 Date: Dec. 27, 2006

Related U.S. Application Data
(60) Provisional application No. 60/583,749, filed on Jun. 29, 2004.

(51) Int. Cl. H02K 31/00; H02K 1/27; H02K 7/02

(52) U.S. Cl. 310/74; 310/156.38; 310/156.41; 310/178

(57) ABSTRACT

A multipolar machine (FIG. 4) with the reduced number of brushes (27) includes a rotor (2) with number of radial layers (2) (1) and 2(2) larger than 1. The radial layers are electrical connected with permanent electrical connections called “flags” (20, FIG. 8).

### CROSS-REFERENCE TO RELATED APPLICATIONS

Related U.S. Patent Applications are:

“Bipolar Machines—A New Class of Homopolar Motor Generator”, D. Kuhhnann-Wilsdorf, Patent Application, filed May 6, 2002. Provisional Ser. No. 10/139,533, Pub. No. 2003/0052564; Pub. Date Mar. 20, 2003.

“Multipolar Machines—Optimized Homopolar Motors/Generators/Transformers”, D. Kuhlmann-Wilsdorf, Patent Application, filed Jul. 8, 2003, PCT Application PCT/US03/22248.

Applicant claims priority for this application to the following:

“Multipolar-Plus Machine—Multipolar Machines with Reduced Numbers of Brushes”, Doris Kuhlmann-Wilsdorf, Provisional Patent Application, Ser. No. 60583749; filed Jun. 29, 2004.

### FIELD AND AIM OF THE INVENTION

The present invention expands the “multipolar machine” (MP machine) invention for which a patent application “Multipolar Machines—Optimized Homopolar Motors/Generators/Transformers”, D. Kuhlmann-Wilsdorf, filed Jul. 8, 2003, is pending. The present expansion of the multipolar machine invention applies in general to machines as defined in the 1^{st}, 6^{th} and 12^{th} claim of the cited patent application, to with

1. A homopolar machine capable of operating as an electric motor, an electric generator, an electric transformer and/or an electric heater comprising:

at least one electrically conductive rotatable rotor configured to flow currents in a plurality of current paths when power is applied;

a plurality of magnetic field sources disposed to apply a magnetic field penetrating the rotor in a plurality of zones and intersecting the plurality of current paths when the rotor is rotated by means of said applied power; and

current channeling means in said rotor provided so as to be parallel to said plurality of current paths during rotation of said rotor;

6. A homopolar machine according to claims 1 . . . wherein a plurality of said magnetic field sources are configured into at least one of an outer and an inner magnet tube.

12. A homopolar machine according to claim 6 wherein said magnetic field sources are magnets that pair-wise face each other across the wall of said at least one rotatable rotor;

In preferred embodiments, the present invention applies to multipolar (MP) machines that are characterized by
A “current channeling” rotationally symmetrical rotor set of N_{T}≧2 similar, concentric, mechanically bonded, electrically conductive but mutually electrically insulated layers of typically but not necessarily constant wall thickness, that singly are dubbed a “rotor” and collectively constitute a “rotor set”. “Current channeling” herein means what technically should perhaps be more accurately called “one dimensional current channeling” because it is characterized by high electrical conductivity in one direction (the “current channeling direction” or synonymously the “current flow direction”) but high electrical resistance at right angles thereto. In a current channeling material of this kind, a charge at any one point may freely move along a line defined by the orientation of the preferred, i.e. “current flow” direction, that, however, may gradually change. Thereby a one-dimensional current-channeling material defines a field of flow lines, perhaps best comparable to an electrical field, i.e. with perhaps meandering but not circulating lines of force. In the sense of theoretical physics there also exists “two-dimensional” current channeling with high electrical conductivity in two orthogonal directions of high electrical conductivity and high resistance normal to the surfaces defined by these. In such a case, at any one point on electrical charge could freely move over the surface defined by the orientations of the two preferred current flow directions but not transit between neighboring surfaces. In fact, while most individual rotors contemplated in the present invention are essentially one-dimensionally current channeling, namely by virtue of being composed of rods, an arrangement of concentric rotors without homogeneous electrical conductivity are a case of two-dimensional current channeling
The preferential direction of current channeling in all of the rotors is such that currents can flow from end to end (typically but not parallel to the rotation axis), but cannot flow circumferentially. The current channeling means or “current channeling barriers” are typically, but not necessarily, insulating layers. In order to prevent short circuits among parallel current paths, the current channeling barriers must be continuous and extend through the thickness of the individual rotor walls.
Eddy current barriers are current barriers that inhibit small-scale circulatory currents. Typically, current channeling barriers can serve as eddy current barriers, BUT need to be spaced more densely than would be typically necessarily for the sole purpose of current channeling. Further, unlike current channeling barriers, eddy current barriers need not necessarily be continuous nor penetrate through the thickness of the rotor walls. A rotor made of an assembly of mutually insulated, axially extended uniform metal “rods” of <˜ 1/16″ thickness will therefore be both current channeling and protected from damaging eddy currents.
Two concentric cylindrical tubes (the “inner” and “outer” magnet tube) that are geometrically conformed to the rotor, and in the gap between which the rotor or rotor set rotates.
A multiplicity of magnets, affixed to the magnet tubes so as to face the rotor, and which extend parallel to the current channeling direction in the rotor(s) but with radial direction of magnetization. The magnets in the two magnet tubes are pair-wise radially aligned across the gap such that they create (typically strip-shaped) “zones” of radial magnetic flux penetrating the rotor or rotor set, wherein (i) the zones are parallel to the rotor current channeling direction and (ii) the radial direction of magnetic polarization alternates between N-S and S-N.
Means to generate current paths arranged such that currents in the rotor or rotor set, flow (typically sequentially) from zone to zone, and do so in one axial direction in N-S zones and in the opposite axial direction in S-N zones, to the effect that the Lorentz forces in all zones have the same sense of rotation.
One of the magnet tubes being rigidly connected either to the static surroundings to serve as stator, or rigidly connected to the MP machine axle (either to drive the MP motor, or to be acted on by an externally applied torque in case of an MP generator), while the other magnet tube is centered on the axle by means of bearings. At rest as well as during MP machine operation, the two magnet tubes are held in (nearly) fixed angular alignment via the forces of attraction between the radially opposing magnet pairs.

Herein and below the words “current channeling”, “current channeling means”, “current channeling barriers”, “eddy current barrier”, “inner magnet tube”, “outer magnet tube” and “zone” have the same meaning as in the cited claims 1, 6 and 12, and/or in the pending patent applications “Bipolar Machines—A New Class of Homopolar Motor Generator”, D. Kuhlmann-Wilsdorf, filed May 6, 2002. Provisional Ser. No. 10/139,533, Pub. No. 2003/0052564; Pub. Date Mar. 20, 2003 and “Multipolar Machines—Optimized Homopolar Motors/Generators/Transformers”, D. Kuhlmann-Wilsdorf, Patent Application, filed Jul. 8, 2003, PCT Application No. PCT/US03/22248.

A characteristic of MP (i.e. multipolar) machines, in general, is the almost arbitrarily large number of possible zones per rotor that is made possible through current channeling together with the multiplicity of opposing magnet pole pairs in the magnet tubes. By this construction, any one current passage along any one of the zones in a rotor, in either to or fro direction, represents a “current tuni”, such that each current turn produces a Lorentz force in the same direction. In a motor the sum of those Lorentz forces produces the torque, in a generator produces the output current, and in either case produces the machine voltage which prior to those inventions was chronically low so as to require uncomfortably high machine currents. Consequently, prior to those inventions, almost universally homopolar machines had, and still have, only one current turn per rotor, while current channeling permitted to increase this to two turns per rotor in bipolar machines. The MP machine invention with its pair-wise opposing magnet pole pairs then permitted the almost unlimited increase of turns per rotor without the need for one current return along the rotor length per turn as in Sakuraba, U.S. Pat. No. 5,032,748. Further, the fact that current channel barriers also provide eddy current barriers, provided that they are suitably densely spaced (e.g. at ˜ 1/16″) was previously overlooked so that previous homopolar machines without current chainels/eddy current barriers could not achieve acceptably high efficiencies.

However, up to this point, MP machines, along with all other previous homopolar machines, required two electrical brushes per current turn, situated on slip rings at each end of the turns. On account of energy losses through brushes, limited brush life times, extra cost and a measure of risk of failure, this is a considerable obstacle against the wide-spread application of all of those machines, no matter what their other merits might be and to what degree electrical brushes, especially metal fiber brushes, may be, and already have been, perfected.

### GENERAL DESCRIPTION OF THE INVENTION

Goal, Definition of “Flags”, and Current Paths Without Brushes Via Flags

Electrical brushes in homopolar machines lead the machine current, or parts of it, from the outflow end of one zone to the start of the next. Since, preferably, the requisite current connect-ions in multipolar (MP) machines are between neighboring zones and these have opposite radial direction of polarity, previous MP machines require brush pairs side by side on the same slip ring. This geometry is schematically depicted in FIG. 1. It shows that previous MP machine with N_{D} zones and a rotor set of N_{T} rotors, require N_{B}=2N_{T}N_{D} brush sites. Hence N_{B} could amount to hundreds if not a thousand in a large machine, besides the fact that each brush site would commonly be composed of multiple individual brushes on account of the restricted maximum size and current density of electrical brushes.

In order to drastically reduce N_{B}, the present invention substitutes electrical brushes with permanent internal electrical connections inside a rotor set, dubbed “flags”. The invention is based on the fact that in any current channeling rotor, the footprint of a brush on its slip ring, permits current to flow exclusively in current paths touched by the brush, e.g. in all “rods” composing the rotor that are touched by the brush, but in no others. Therefore currents can flow between brushes on opposite ends of a current-channeling rotor only through current paths that are touched by both brush footprints, i.e. are aligned with the same zone. Similarly, in a current-channeling rotor with mutually insulated current paths, passing a current from any one zone into another via brushes, e.g. from zone j in rotor A to zone k in rotor B, requires the placing of at least one brush in line with zone j on a slip ring of rotor A, and another brush in line with zone k on a slip ring of rotor B, in the desired direction of the current, and establishing an electrical colmection between the two brushes.

In FIG. 1 such conductive connections by means of brushes are indicated by short horizontal arrow heads for the simplest kind of MP machine with multiple parallel zones and multiple rotors in a rotor set. Herein, the arrow heads at the same time indicate the current direction as driven by the applied voltage or the Lorentz forces in the zones, as the case may be.

According to the present invention, one may achieve current flow from zone to zone between an “in” and an “out” brush, without the use of electrical brushes, through substituting electrical brushes by permanent electrical connections, i.e. “flags”, along the way, such as to permit the requisite current transitions between zones at one or both rotor ends. This means that, at the rotor ends, one must provide suitable electrical connections between the rods of the rotor.

The opportunity to do so exists because, as already stated, only current paths that are partially covered by both the “in” and “out” brush foot prints can conduct current between them, and no others. Hence no flags, except those on a current path between the “in” and “out” brush can possibly contribute to the current conduction. Of course, in machine operation, the participating rods and flags constantly change, but the current path will stay constant.

Translating the above principle into practice is complicated because currents can flow equally well in two opposite directions. Therefore, in a rotor made of parallel rods connected through flags, short-circuiting between currents circulating in opposite directions, e.g. clockwise and anti-clockwise, will destroy the intended effect of leading currents systematically from one zone to the next. The desired elimination of electrical brushes by means of flags therefore requires the construction of current paths free of the described short-circuiting. At least three successful paths for the elimination of electrical brushes through flags exist and have been identified. All of these interconnect two adjacent rotors as explained below. Rotor sets with larger even numbers of rotors, i.e. with N_{T}=4, 6, 8 etc, may be constructed by assembling concentric rotor pairs of N_{T}=2.

Radial Zig-Zag Paths

As the first example, FIGS. 2A and 2B clarify the construction of a radial “zig-zag” interconnection between two adjacent zones in a set of N_{T}=6 rotors. Such a zig-zag arrangement will conduct the current in radial direction through the thickness of the rotor wall. It will reduce the number of required brushes to two per zone, instead of two brushes per turn, i.e. reduce N_{B} by the factor of N_{T}. The benefit of this rises with the number of rotors in a set.

Alternative Magnet Arrangements

FIGS. 2A and 2B do not show any particular magnet arrangement. In fact, MP-Plus machines may be constructed with any desired magnet arrangement. FIG. 3 indicates possible choices, including a modified Hallbach arrangement at top, an arrangement of modified composite horse-shoe-type magnets in FIG. 3B, plus more complex forms in Figures C and D. The choice between these and any other magnet morphologies will depend on a not yet completed detailed analysis of the resulting magnetic flux densities in the zones relative to weight and cost of the magnets.

Circumferential Connections—“Opposing Full Circuits” and “Mirrored Half Circuits”

A much more drastic reduction of N_{B} than through the above radial zig-zags may be accomplished through circumferential connections. However, in order to inhibit short-circuiting through clock-wise versus anti-clockwise current flow, the path is interrupted through breaking the cylindrical symmetry of the magnet arrangement. One version, dubbed the “opposing full circuits arrangement” is shown in FIG. 4, the other, dubbed the “mirrored half circuits arrangement” is shown in FIG. 5.

A preferred arrangement of slip rings, flags and brushes if more than two rotors are used in a set is depicted in FIGS. 6 and 7

Making Flags and Connections Through Flags

As clarified in FIGS. 2, 4 and 5, in preferred embodiments, “flags” conduct current between correlated positions in neighboring zones in neighboring rotors of a rotor set. Typically, this means a circumferential displacement between the ends of a flag by the zone periodicity distance, Lₚ, equal to twice the tangential width of the magnet poles as projected on the rotor midline, i.e. Lₚ=2Lₘ in the nomenclature of FIG. 3A, over a radial distance of somewhat less than the wall thickness of two rotors, i.e. typically less than Lₘ/2. The tangent of the angle which the average current conducting flag area subtends against the rotor mid-line is thus typically ˜1:3 or less, for an angle comparable to or smaller than 20°. Further, in order not to distort the current flow though rotor zones and brushes, there should be at least three, and preferably five or more flags per brush, while Lₘ may be as small as 1 cm or even less. Typically Lₘ will be about 1″, with an estimated maximum near 3″ even in large machines. Also, the flags connected to the rods touched by one brush footprint must carry the current through that brush at a current density that should preferably not greatly exceed the current density in the rotor rods. To simultaneously fulfill all of these requirements is not a trivial task. FIGS. 8 to 11 illustrate the geometrical conditions and possible methods of construction.

Specifically, FIG. 8 shows how the two rotors in an N_{T}=2 rotor set could be connected by “flags” composed of a cylindrical, and partly conical, assembly of rods matching those of the two underlying rotors.

A much more elegant and compact construction is depicted in FIG. 9. It is referred to as “grooves and inserts” and is clarified in FIGS. 9A and 9B. Namely, low machine volume is typically valuable, and this may well be the most compact possible form of flags. However, it may prove to be more costly than the two methods shown in FIGS. 10 and 11, dubbed the flags between poles and the flags between tabs, respectively.

As a variant of the “flags between tabs” method, one may also choose to conductively insert the “tabs” between mutually insulated pairs of two adjoining rods, instead of forming them into parts of a slip ring as in FIG. 11. Practical experience suggests that this last method could well be the most economical method of those discussed herein. It is not doubted that further morphologies for flags will be devised in the future.

Mass Production Method for Making Large MP-Plus Machine Rotors from Thin Metal Sheet

While individually, flags are not difficult to make, and while they will sharply reduce the number of brushes required, namely, from N_{B}=2N_{T}N_{Z} to between eight and as few as three brush sites per machine, they are liable to constitute a significant share of the cost of Multipolar-Plus machine construction, in fact probably rising with machine size. This is so because the suppression of eddy currents will require rotor rods to be no wider than in the order of 1/16″ thick for even the largest machines, e.g. with ten plus feet rotor diameter. Hence a large machine may well require 4000 flags or so, and pending the development of mass production techniques, these would have to be fitted by hand. The new method that is clarified by means of FIGS. 12 to 16 is proposed as a preferred method of mass producing MP-Plus machines, from modest to the largest sizes.

Mass Production Method for Making Small MP-Plus Machine Rotors from Metal Wire

The production method outlined in FIGS. 12 to 16 will be unsuitable for making the rotors of small MP-Plus machines, e.g. as for electric wheel chairs. According to the present invention small MP-Plus machines may be made from wires, as outlined in FIGS. 17 to 19. A particular advantage of this method is considered to be possibility of producing MP-Plus motors that are so small that they would be difficult if not impossible to make by other methods.

The Great Versatility of MP-Plus Machines, Including Flared Rotors

The great versatility and adaptability of MP-Machines in terms of size, speed, power and uses, is not impaired by the elimination of brushes in favor of flags. It rests on the fact that, in principle, each current turn can be regarded, and can be treated, as an individual machine. By reducing the number of brushes and slip rings, that versatility and adaptability is still increased, e.g. by the use of flared rotors, as well as the possibility of omitting a central axis, as indicated in FIGS. 20 to 22.

Enclosures About Slip Rings and Brushes

The reduction of slip ring and brush footprint area will facilitate the possibility to immerse MP machines in water, e.g. for pumping as illustrated in FIGS. 20 to 22.

This may require the construction of enclosures about slip rings and brushes as indicated in FIG. 23.

A Prototype

The concept of circumferential zig-zags, of flags, and how to make them, was tested by means of a prototype, the cross section of which is shown in FIG. 24, including some of the most important dimensions.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein

FIG. 1 is a schematic illustration of the arrangement of zones, electrical brushes and current flow in previous multipolar machines

FIG. 2A is a semi-schematic cross-section of part of a rotor and adjoining magnets in an MP-Plus machine with radial zig-zag connections.

FIG. 2B is a semi-schematic longitudinal cut through the same machine shown in FIG. 2A but also showing grooves and inserts at the rotor ends as well as electrical brushes at one end.

FIG. 3A is a semi-schematic view of part of a 2-layer MP rotor in cross section with pairs of surrounding magnetic field sources in the form of permanent magnets in a modified Hallbach arrangement.

FIG. 3B as FIG. 3A but with composite modified horse-shoe-type magnets.

FIG. 3C as FIG. 3A but with an unusual arrangement of triangle-shaped permanent magnets embedded in a magnetic flux-return material.

FIG. 3D as FIG. 3A but with a different morphology of permanent magnets embedded in a magnetic flux-return material.

FIG. 4 is a schematic cross section through an MP-Plus machine with opposing full circuits

FIG. 5 as FIG. 4 but for a mirrored half-circuits arrangement.

FIG. 6 is a semi-schematic lengthwise cut through an MP-Plus machine with slip rings at only one end, as at lower left in FIG. 4, but with an N_{T}=8 rotor set composed of four rotor pairs.

FIG. 7 as FIG. 6 but for a machine with slip rings at both ends.

FIG. 8 is a perspective view of part of an MP-Plus machine with an N_{T}=2 rotor and “flags” in the form of rods assembled into a modified partly cylindrical partly conical shape.

FIG. 9 is an illustration of flags of the “groove and insert” type, in A shown in cross section and in B in a perspective cut.

FIG. 10 is an illustration of “flags between poles”, seen in semi-schematic cross-section in A and in a perspective view of the rotor end in B.

FIG. 11 as FIG. 10B but for “flags between tabs”.

FIG. 12 shows an R-unit blank and strips of the kind from which an MP-Plus rotor can be assembled.

FIG. 13 is a perspective view of the first step in shaping an R-unit from a blank as in FIG. 12.

FIG. 14 is a perspective view of a machine by which the shape of FIG. 13 may be made and shaped blanks can be assembled into “R-units”, i.e. sections of an MP-Plus rotor.

FIG. 15 is a perspective view of an R-module and a shell in which R-modules may be assembled into section of MP-Plus rotors.

FIG. 16A is a cross sectional view of an MP-Plus rotor that was formed through the method of FIGS. 12 to 16.

FIG. 16B, as FIG. 16A but an end-view.

FIG. 17A shows a ribbon of mutually insulated, fused wires, resembling a computer cable, as bent into a 90° angle, as part of the process of producing rotors of small MP-Plus machines through winding of wires.

FIG. 17B shows a stage in the winding of a wire ribbon as in FIG. 17A, in the production of the rotor of a small MP-Plus machine.

FIG. 18A illustrates the partially formed rotor after the completion of the winding depicted in FIG. 18A.

FIG. 18B is a cross section of the part shown in FIG. 18A after it has been bent and fused into a cylinder.

FIG. 18C as FIG. 18A but with a different construction at the ends.

FIG. 18D as FIG. 18B but derived from the shape of FIG. 18C.

FIG. 19 is a simplified perspective view of the completed machine

FIG. 20 is a cross sectional view of an MP or MP-Plus submerged pump with flared rotor but without central axle.

FIG. 21 as 20 but with different propeller arrangement.

FIG. 22 as FIG. 20 but with barrel-shaped rotor and different propeller arrangement

FIG. 23 shows a semi-schematic cross section through an enclosure for use with submerged MP-Plus machines

FIG. 24 cross section of a small MP-Plus prototype.

### DESCRIPTION OF PREFERRED EMBODIMENTS

Referring now to the drawings, wherein like reference numerals designate identical or corresponding parts throughout the several views, the present invention will now be described.

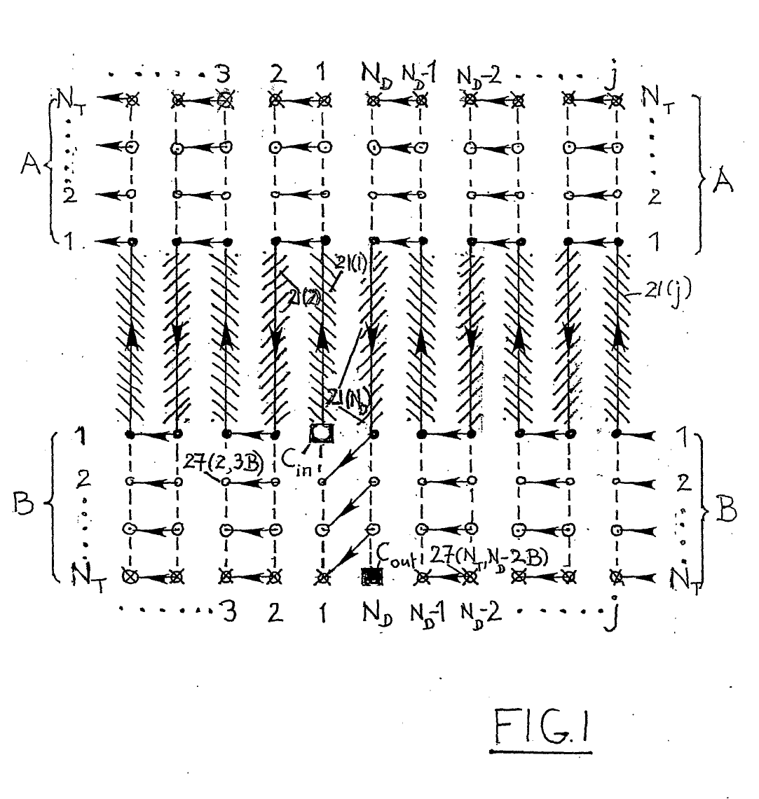

1. Arrangement of Brushes, Zones and Current Flow in Previous MP Machines (FIG. 1)

FIG. 1 shows the current flow pattern in a multipolar motor that is powered by a single DC current source. It uses the example of part of a rotor set of N_{T}=4 rotors with an arbitrary number, N_{D}, of current turns per rotor, seen in plan view as if the rotor set were slit in axial direction and flattened. Herein zones 21, i.e. current turns in axially extended strips of rotor set 2 that are penetrated by radial magnetic field B, are shown as vertical parallel strips with diagonal shading in two different orientations, symbolizing opposite sense of orientations of B. These orientations are shown to systematically alternate from zone to zone as expected for magnetic field sources with two (or in general an even number of) opposite poles. As a result, zones 1 and N_{D} have opposite sense of radial magnetization. While this will be a common case, it is not a necessary condition.

In FIG. 1, a (convenient but arbitrary) numbering of the zones is indicated at both ends of the rotor set composed of N_{T} concentric, mutually electrically insulated rotors. The two rotor ends are arbitrarily dubbed “A” and “B” for above and below the zones in FIG. 1, respectively, whereas physically the rotor could have any arbitrary orientation, e.g. vertical in spite of the fact that, mostly for convenience of drawing as well as most practical cases, examples generally assume an axle in horizontal orientation. Further, the zones, and the brushes that connect the conductors in the zones, are numbered in ascending order from right to left, in the order of . . . N_{D}-2, N_{D}-1, N_{D}, 1, 2, 3 . . . .

The slip rings at the “A” and “B” ends of the machine are shown as horizontal lines of symbols that represent the brushes that slide on them. Relative to the zones they are numbered 1, 2, . . . N_{T} (with in this case N_{T}=4) outward from the zone ends. The symbols for the brushes are solid dots (•), small open circles (∘), open circles with a central dot and crossed open circles, for brushes on slip rings 34(1), 34(2), 34(N_{T}-1) and 34(N_{T}), respectively.

In the described depiction of zones, slip rings and brushes in FIG. 1, the pattern of the current flow is indicated by means of solid lines with arrows pointing in the direction of positive current flow. Note here that there is a brush site at both ends of every zone, for N_{B}=2N_{T}N_{D} brush sites in total. Since N_{D} may easily exceed 100, N_{B} can be a large number. Furthermore, often, as also in FIG. 1, each brush site must conduct the full machine current that in large machines can amount to thousands of Ampere, while any single brush can rarely conduct more than a few hundred Amps. Thus the total number of brushes, which each must be held and loaded in a brush holder, can reach into the thousands.

Each current passage through a zone may be regarded, in fact employed, as an independent motor or generator. Therefore, by making different connections between brushes, a sufficiently large MP machine may be operated as a motor, a generator, a transformer and/or heater, singly or simultaneously. This feature remains intact also for MP-Plus machines.

Even though modem metal fiber brushes have achieved very good reliability and long life-times, the discussed overly large number of brushes would seriously impede the widespread use of MP machines, in spite of their impressive other features, such as very high power density and quiet operation, acoustically as well as electronically. This concern was the driving motivation behind the invention of MP-Plus machines that retain all other features of MP machines but eliminate a large part, and in circumferential circuiting all but three to eight brush sites. As already indicated this is achieved by means of “flags”, the word chosen for permanent internal electrical connections in the rotors of MP-Plus machines.

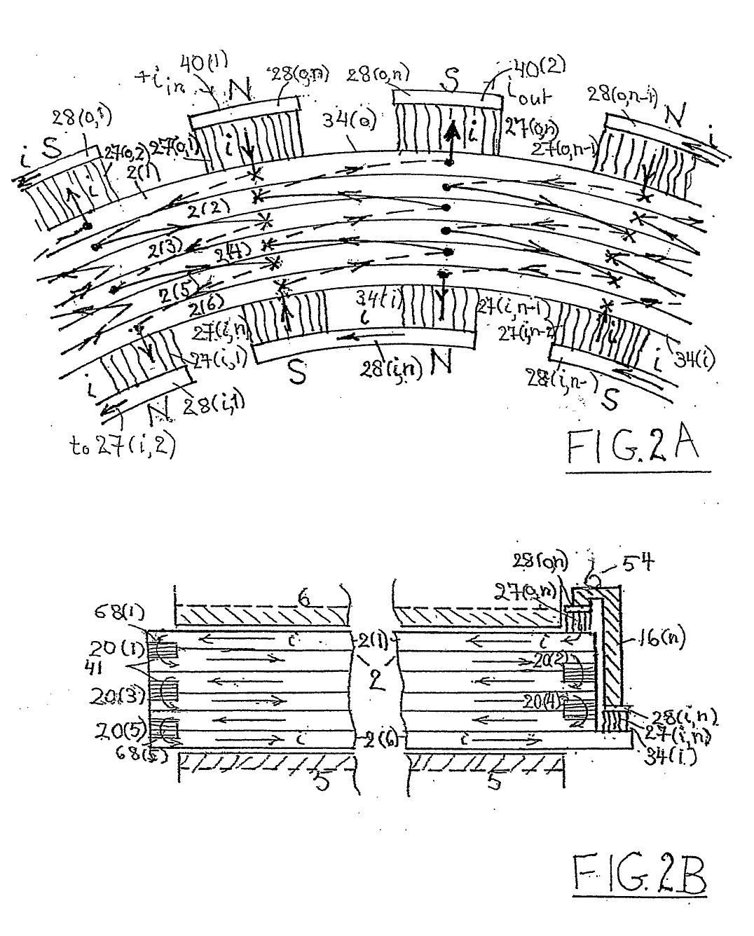

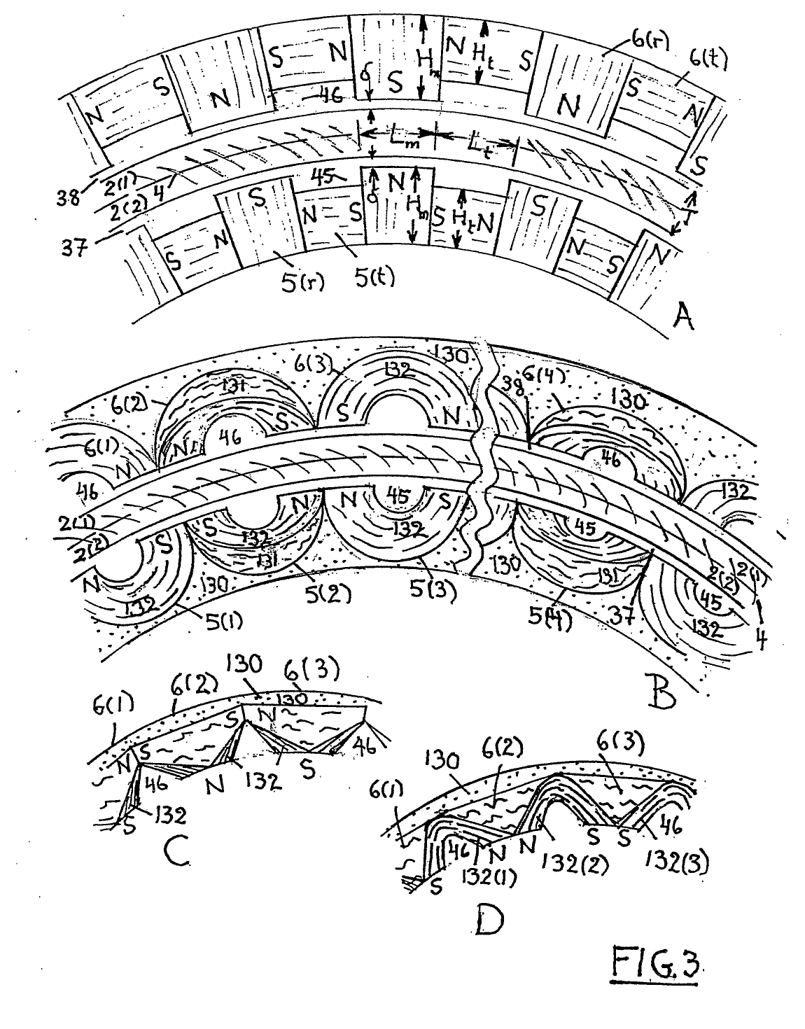

2. Flags Generating Radial Zig-Zag Current Flow in MP-Plus Rotors (FIG. 2)

As already introduced above, in current-channeling rotors, pre-determined current paths may be achieved without the use of brushes by means of “flags” which are permanent internal connections in rotors that conductively connect correlated positions in neighboring zones of neighboring rotors in a rotor set. As an important example of such predetermined current paths, FIGS. 2A and 2B clarify the construction and current flow in a radial zig-zag for the case of an N_{T}=6,rotor set. In FIG. 2A, the indicated brushes (27) and their back plates (28), show the positions and width of the zones, i.e. of the magnets in the outer and inner magnet tube that are not shown. The arrows indicate the current flow direction, i.e. the orientation of the flags, at the front and back end of the rotor via bold and broken arrowed lines, respectively, and the bold dots and crosses at the zone mid-lines show the current direction in the zones, i.e. into the plane and out of the plane of the drawing, respectively. Note also that, as already discussed, flags need to be densely spaced e.g. at a minimum three, and more safely five or more flags per length of brush footprint as projected on the rotor midline. Further, for proper space filling, flags will generally be curved at about the same radius as the rotor.

Specifically, in FIG. 2A, brushes 27(o,1) 27(o,2) . . . 27(o,x) . . . 27(o,n) and 27(i,1), (i,2), . . . 27(i,x) . . . 27(i,n) are shown as sliding on outer (34(o)) and inner slip ring (34(i)). They are pair-wise radially aligned in the zones between magnet pole pairs of alternating radial symmetry with indicated polarity by letters S and N.

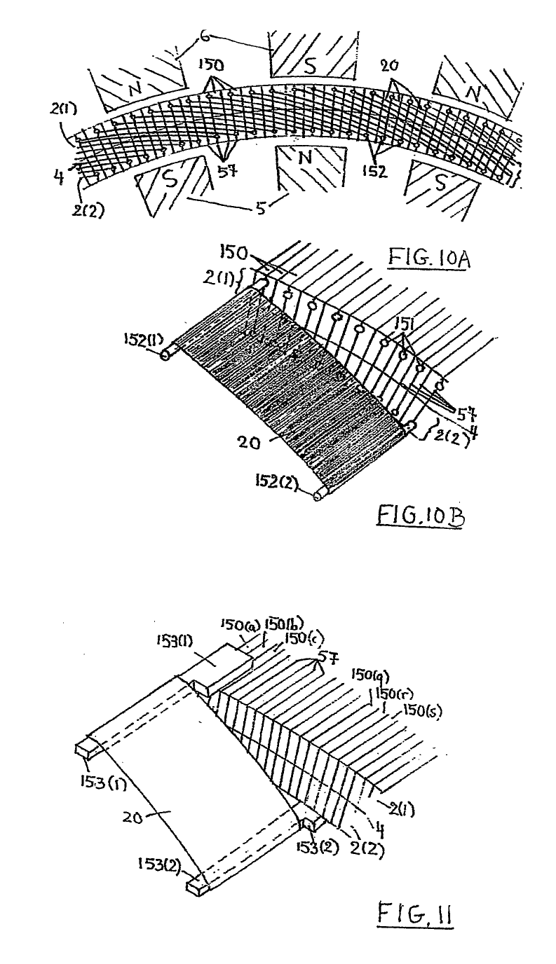

FIG. 2 envisages flags in the form of “inserts (20) in grooves”, as further clarified in FIG. 9. The flags lead the current in the indicated radial zig-zag between correlated brushes on outer and inner slip ring, 34(o) and 34(i). Herein current connections between neighboring rotors in the form of inserts 20(1) to 20(5) in FIG. 2B, are slanted such that in the view of FIG. 2A, the current consistently flows into the plane of the drawing when the N magnet pole is on the outside and in opposite direction when it is on the inside. Consequently, the Lorentz force is oriented in the same sense of rotation everywhere. The opposite slants of the flags in the insets at the two rotor ends to bring this about is shown in FIG. 2A by means of the bold and broken lines for the arrows, as already discussed, and in FIG. 2B by light curved arrows.

The current flow within and between the zones is further clarified in FIG. 2A. Herein the current enters rotor 2(1) through brush 27(o,1) via cable 40(1). It begins its zig-zag flow with an axial passage along the zone to the far end of rotor 2(1) where it passes into rotor 2(2) in the neighboring zone through an insert as indicated. From there it returns to the front end by means of an axial passage through rotor 2(2). Arriving again at the front end it slants down to return to its initial zone but now in rotor 2(3). The current continues to zig-zag through rotors 2(4) to 2(6) into brush 27(i,1). From there, it passes to brush 27(i,2) via connector plate 28(i,1), re-enters the rotor set to zig-zag to brush 27(o,2), on to 27(0,3) via connector plate 28(0,2) and on.

Unless the circuit is broken through an intervening current supply, the current will finally emerge from the right of FIG. 2A, namely through connector 28(o,n-1) and brush 27(o,n-1) zig-zagging through rotors 2(1) to 2(6) to brush 27(i,n-1), through connector 28(i,n) and brush 27(i,n) in a zig-zag to the “out” brush 27(o,n).

As seen from FIG. 2A, except at the “in” and “out” positions, brushes are formed into groups of four each, consisting of two radially aligned brush pairs that are interconnected with an aligned rigid connector pair 28(i,x) and 28(o,x). This geometry permits a considerable simplification of brush holding and load application. Namely, as indicated in FIG. 2B, all four brushes in a group may be presumed to wear at a quite similar rate, and they do not need to be connected to some current supply, as the current simply flows consecutively through them and their connector plates. Therefore, if slip rings 34(o) and 34(i) are arranged to face in the same radial direction, i.e. preferably for simplicity to the outside as in FIG. 2B, the four brushes in any one group may be held together rigidly by means of some electrically insulating structure 16 and may be mechanically loaded together, e.g. by means of a constant force spring 54 that is rigidly connected to the stator, e.g. the outer magnet tube and/or the base plate, as may be preferred.

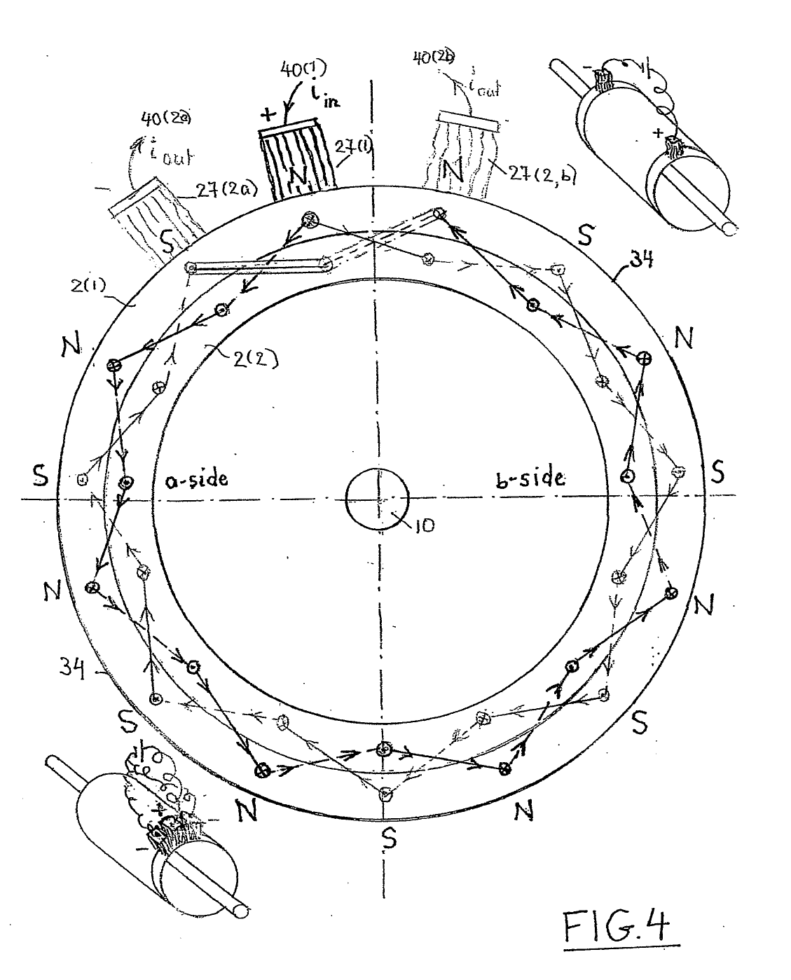

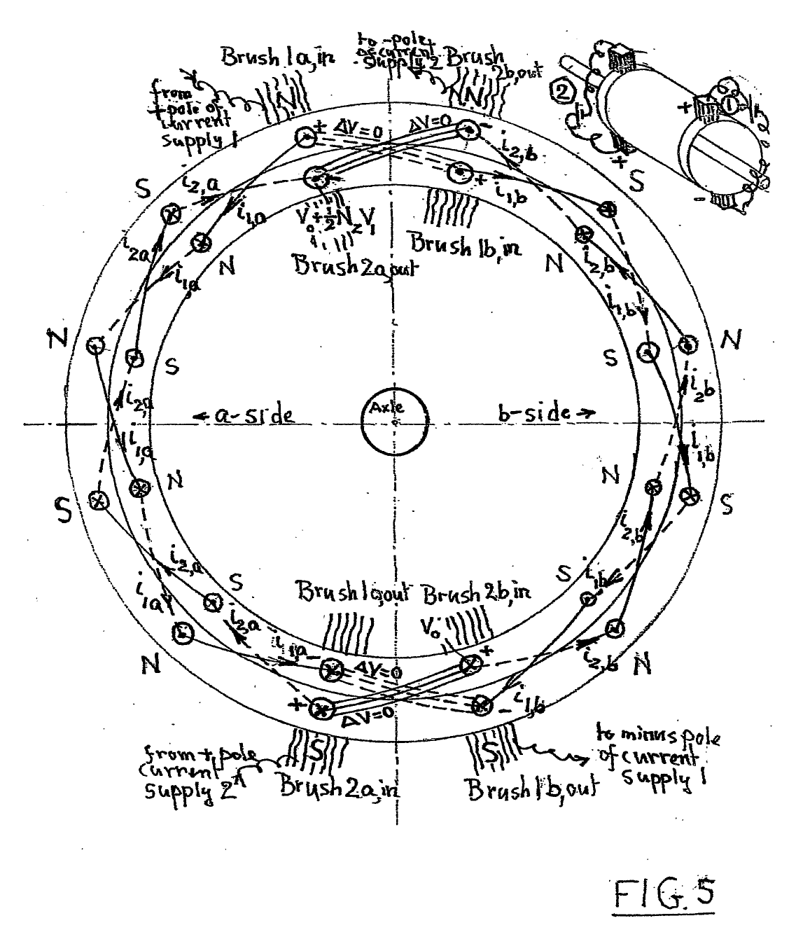

3. Alternative Magnet Configurations (FIG. 3)

FIG. 3 shows a cross section through part of an N_{T}=2 rotor with a selection of possible magnet arrangements in the two magnet tubes. Herein 2(1) and 2(2) are the two rotors in the rotor set, 5(r) and 5(t) are permanent magnets in the inner magnet tube with radial and tangential magnetization direction, respectively, and similarly 6(r) and 6(t) are magnets in the outer magnet tube with radial and tangential magnetization direction. Gaps 45 and 46 between neighboring radially oriented magnets are axially extended channels suitable for the passage of cooling fluid (as is a preferred arrangement for all MP machines). Next, 130 and 131 are structural materials in which the magnets are embedded. Among these, 130, with a dotted pattern, is a non-magnetic material that is preferably light and strong, i.e. could be a plastic, a rosin or a ceramic, whereas 131, indicated by short wavy lines, is a flux return material, i.e. typically will be a magnetically soft iron alloy. Finally, 132, characterized by longer lines, is a permanent material.

FIG. 3 with the indicated possible arrangements in FIGS. 3A to 3D, plus still a large number of other permutations of arrangements that are not shown, is a highly relevant part of the present invention. Namely, in general terms, for same shape, construction and rotor size and shape, the power of MP and MP-Plus machines is proportional to B² where B is the average flux density at the geometrical projection of the magnets on the midline of the rotor wall. Further, if Lₘ, the projected width onto the rotor midline 4, of the poles of the permanent magnets that face each other across the gap between magnet tubes 5 and 6, is not equal to L_{g}, the width of the gaps between the magnets, L_{g}, then the machine power is also approximately proportional to Lₘ/(L_{g}+Lₘ). Additionally, the power density of a multipolar machine rises and the cost decreases, if the same machine power can be attained with a lower total mass of magnets. It therefore is very likely that machine power, power density and cost can be optimized by varying magnet shapes, and that Hallbach arrays with L_{g}=Lₘ, as in FIG. 3A, which were almost exclusively used so far, are not necessarily the best.

However, it seems that the magnetic field strengths between such irregular arrangements as in FIGS. 3B, 3C and 3D have never as yet been determined. Therefore, the desired optimization of magnet arrangements is liable to yield valuable results but requires the determination of the strength and spatial distribution of B, and most importantly the average magnetic flux density in the zones of the rotor. This, in turn, will require a finite-element analysis that has not as yet been performed. Even so, in accordance with the present invention, intuitive visualization of the distribution of the magnetic flux density between the magnet poles suggests that the non-traditional and “integrated” magnet shapes and rotor constructions indicated in FIGS. 3B, 3C and 3D can yield better B values per magnet mass than the best modified Hallbach arrangements of the kind indicated in FIG. 3A. Among others, this expectation is based on increased Lₘ/L_{g} values for decreased total magnet mass at same pole widths, to yield expected increased B values per unit of magnet material. For these the dependence of B on the various parameters are to be determined via finite element analysis as already stated.

Factors involved in the designs of FIGS. 2B to 2D that are expected to beneficially influence multipolar machine power density, in line with the outlined considerations, are, firstly, increased Lₘ and Lₘ/(L_{g}+Lₘ) values through placing same-sign magnet poles side by side (as in FIGS. 2B, 2C and 2D); secondly, at same pole face geometry, reduction of the flux line lengths for a complete circuit of B lines through two opposing magnets; e.g. in FIG. 3B passing from, say, an N pole to an S-pole through a magnet in the outer magnet tube, across the rotor on to the N-pole and thence the correlated S pole of a the opposite magnet in the inmer magnet tube, and back across the gap to the initial N-pole. As will be seen, such a circuit is longer on the left side of FIG. 3B than on its right side. The expectation is that the correlated increase of flux density in the zone of the rotor due to the longer circuit path on the left side will be more than outweighed by the lower mass on the right; third, through decreasing the relative volumes of magnet material to flux return material as in neighboring magnets on the same side in FIG. 3B. Intuitive expectation is that the magnets of same shape and similar weight but composed of only magnet material 132 as compared to a mixture of flux return 131 and magnet material 132, will produce more closely the same B values in the zones than corresponds to the relative weight of the more costly magnet material. If so, the magnets of mixed material will save cost. Similarly, if the B values in the arrangements of FIGS. 3C and 3D should, as expected, turn out to be more nearly similar than the relative mass of magnet material in them, then the shape of FIG. 3C would be preferable to that of 3D on account of cost savings. This, then, would argue for the use of magnets with significant cross section reduction with distance from the interface, while magnets as in FIG. 3A and on the left (but not on the right) of FIG. 3B have constant values of their cross sections, independent of distance from the gap. Note that this criterion would also argue for the second point above, i.e. shortened flux line length for a circuit.

In summary, according to the present invention, magnet arrangements in the magnet tubes that comprise a multiplicity of permanent magnets with (i) triangular cross sections as in FIG. 3C, (ii) pyramidal cross sections as a permutation of triangular magnets, i.e. having a blunted apex and/or broken sides, as found in Eqyptian pyramids, (iii) pair-wise pyramidal cross sections as in FIGS. 3C and 3D, (iv) pairs of magnets of same polarity side-by side so as to increase the zone width as in FIGS. 3C and 3D, and (v) composite structure of permanent magnet material and magnetically soft ferro-magnetic material, are expected to improve the value of B in the zones at reduced volume and/or cost of magnet material.

4. Circumferential Zig-Zags—Opposing Full Circuits (FIG. 4)

FIG. 4 shows the cross section of an MP-Plus rotor set of outer 2(1) and inner rotor 2(2) with an opposing full circuit design indicated magnet and brush positions. One decisive feature of the opposing full circuits construction, as also in this example, is a single interruption of the regular N/S S/N N/S S/N sequence of the magnet poles about the rotor circumference, via two magnet pairs of same polarity side by side. Specifically, in FIG. 4 there are two N/S N/S pole pairs side by side, namely with the N-pole on the outside, in the 12 o'clock location.

The second critical element in constructing an opposing full circuits MP-Plus machine is providing both rotor ends with flags that consistently connect points at the end of rotors 2(1) and 2(2) that are one periodicity distance apart, i.e. are separated by 2Lₘ circumferential distance if magnet and gap width are alike. Herein, on each side, all flags are slanted in the same way.

In the same manner as in FIG. 2A, FIG. 4 shows the slants of the flags on the two rotor ends by means of straight lines between the mid-points of the zones in the inner and outer rotor, whereby solid and broken lines indicate the front and back end of the rotor set from the standpoint of the viewer, respectively. These lines, at the same time show the current direction by means of the arrow heads on them.

Disregarding for the moment that there are two current circuits, one in clockwise and the other in anticlockwise direction, given in weaker and stronger lines, respectively, it will be seen that all continuous lines slant from the inner to the outer rotor when proceeding in anticlockwise direction, and all broken lines slant from the inner to the outer rotor when progressing in clockwise direction. This means that from the observer's viewpoint of FIG. 4, the flags on the two rotor ends slant in opposite direction, but that they slant in the same direction when each end is viewed from the outside.

On account of this arrangement, an axial current path in zone n in outer rotor 2(1) can receive current from the corresponding current path in inner rotor 2(2) from zone n-1 at one end, and lead the current to the same corresponding path in the inner rotor 2(2) in zone n+1 at the other end. For example, the front end of N/S zone #8 of the outer rotor may receive a positive current from the inner rotor in S/N zone #7 and at the back end lead the current to the inner rotor in N/S zone #9. This geometry requires that at both ends the flags slant inward in clockwise direction when viewed from the outside.

The motor action will become clear when considering current flow from a brush placed in line with one of the double N poles, say the left one in FIG. 4, labeled 27(1),that is connected via current lead 40(1) to, say, the positive pole of a current supply, making brush 27(1) the positive “in” terminal brush. As will be seen when tracing the current paths indicated in FIG. 4, the current emanating from the “in” brush 27(1) can take two routes. These end up at brushes 27(2a) and 27(2b), respectively, which are aligned with the zones on either side of the “in” brush. Correspondingly, “out” brushes 27(2a) and 27(2b) are connected to the negative pole of the current supply, namely in FIG. 4 via electrical connections 40(2a) and 40(2,b), i.e. they provide two symmetrical “out” terminals.

As illustrated in FIG. 2, then, the result of this arrangement is that a positive “in” current entering the outer rotor through brush 27(1) splits into two parallel paths that circle around the rotor set in opposite directions. One of these, in FIG. 4 given in bold line strength, begins with an axial flow through rotor 2(1) in the “in” zone, arrives at the back insert and by it is led in anti-clockwise direction into the neighboring zone but now in rotor 2(2). In that zone it travels axially back to the front end and then, again in anti-clockwise direction via the front insert, to the next zone in rotor 2(1). By repeating this zig-zag between axial traverses of rotors 2(1) and 2(2), transitioning from zone to zone in anti-clockwise direction by means of the two inserts, the current progresses around the rotor set until it reaches “out” brush 27(2,b). The other current branch, given in light line strength, leaves brush 27(1) to enter rotor 2(2) in the neighboring zone in clockwise direction via the front insert, and, again in repeated axial flows but now joined by generally clockwise connections, circles about the rotor set until it reaches brush 27(2a) and the negative terminal via connection 40(2a). The double lines connecting brush sites 27(2a) and 27(2b) indicate that these are at the same electrical potential, as are the two ends of the potential axial flow lines connecting the two along the “in” zone of rotor 2(2). Thus there will be no current flow between those two brushes.

Note that all axial flows are into the plane of the drawing, i.e. are indicated by means of crosses, in zones for which an N-pole is on the outside, and the reverse for S-poles on the outside. Clearly this must be the case when all Lorentz forces are to produce the same sense of rotation. Also note that, with two exceptions, the two current paths travel once along every zone in both rotors, always such as to experience a Lorentz force in the same sense of rotation, as indicated by the encircled dots and crosses in FIG. 4 that symbolize current moving into and out of the plane of the drawing. The exceptions are the two axial passages that would connect the two “out” brushes. Thus the potential work input through those two “turns” in the motor mode, or their potential voltage increment in the generator mode, are deliberately sacrificed. In fact these, too, could be captured, e.g. by moving the two “out” brushes to be in line with the “in brush” but on the opposite end of rotor 2(2). This, then, would require a second slip ring, either on the inside of rotor 2(2) at the front end, or on the outside of rotor 2(1) at the back end.

The creation of a second slip ring and consolidation of two “out” brushes into one could be worthwhile for special reasons, e.g. positioning of the current supply terminals, provision of a particular geometry or mode of machine cooling, or moving brushes of opposite polarity farther apart in order to reduce leak currents. More typically, the advantage of needing only a single slip ring and having all brushes in close proximity will outweigh the loss of two in 2N_{Z} current passages. However, the option exists and the two geometries are indicated in the small sketches at bottom left and top right of FIG. 4.

5. Circumferential Zig-Zags—Mirrored Half Circuits (FIG. 5)

A further option of achieving circumferential current flows almost free of electrical brushes, namely the “mirrored half circuits” is illustrated in FIG. 5. This requires two neighboring magnet pole pairs of same polarity side by side but of opposite orientation and in opposite radial positions. These are shown in the 12 o'clock and 6 o'clock position. Further, FIG. 5 uses the same conventions and symbols as FIG. 4 but in this case the flags have the opposite slant from that in FIG. 4.

The morphology of current flow in this Figure differs from that of FIG. 4 in that there are now not two but four current branches, two each for the two sides of the rotor that are labeled a-side and b-side. Again the symbols of circled dots (for flow towards the viewer) and crosses (for flow into the plane of the drawing) indicate the axial flow direction of the positive current. An again, as in FIG. 4, all axial current flows, in both branches, are associated with the same flow direction when an N-pole is on the outside, and with the opposite flow direction when an N pole is on the outside, except that now the direction is inversed on account of the inverted slant of the flags. Thus, again, at a given polarity of the brush connections, the Lorentz force acts in the same sense of rotation for all axial flows, as must be the case for proper functioning of the machine. Changing the brush polarity will reverse the direction of machine rotation.

The morphology of FIG. 5 requires at least two slip rings and these on opposite ends of the rotor, optionally on the outside or inside of the rotor set. Specifically, in FIG. 5 the “12 o'clock” positive terminals are situated on the front of the rotor and the negative terminals at the back, and the reverse is true for the “6 o'clock” negative terminals. Again, the double lines indicate same potential for the two connected brushes and thus no current. This, then, permits that one consolidated brush, in lieu of two separate brushes, is placed either on the outside or the inside of the rotor. However, because an outside slip ring will be by far more easily accessible, one will generally choose only outside slip rings.

Given, then, two outside slip rings, one at each end, in the arrangement of FIG. 5, the positive “12 o'clock” (1a,in) and (1b,in) brushes can be consolidated into a single positive “lin” brush on the outside slip ring at the front , while the negative (2a,out) and (2b,out) brushes may be consolidated into a single (2out) brush on the outside slip ring at the back. Much the same consolidation can be made at the “6 o'clock” position, namely such that on the front slip ring there will be a single negative (1out) brush at the 6 o'clock position and a single positive (2in) position on the back slip ring. The small insert sketch at top right of FIG. 5 sketches that arrangement.

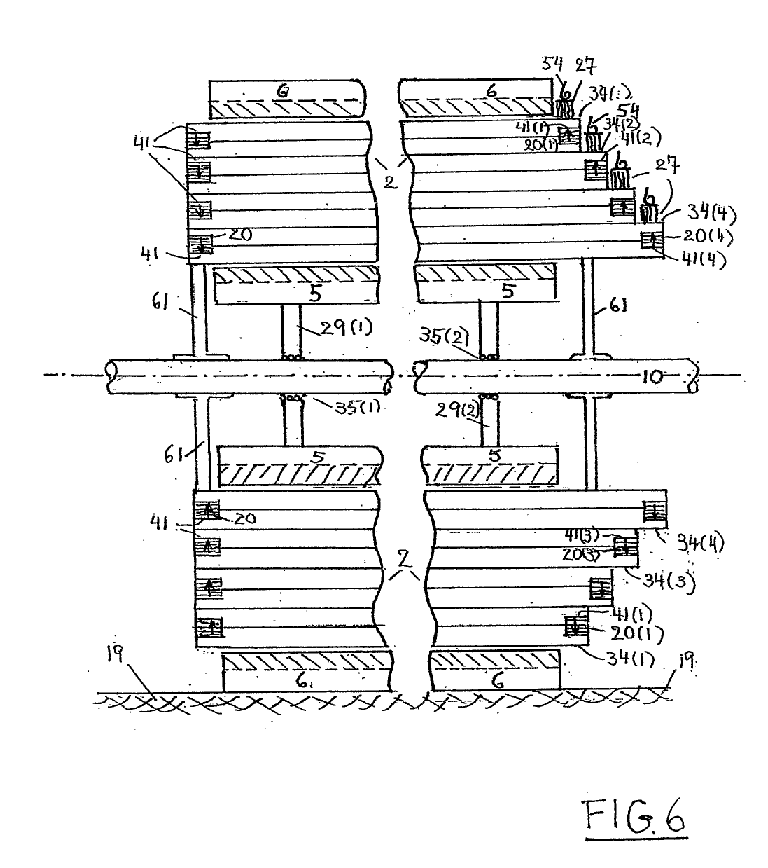

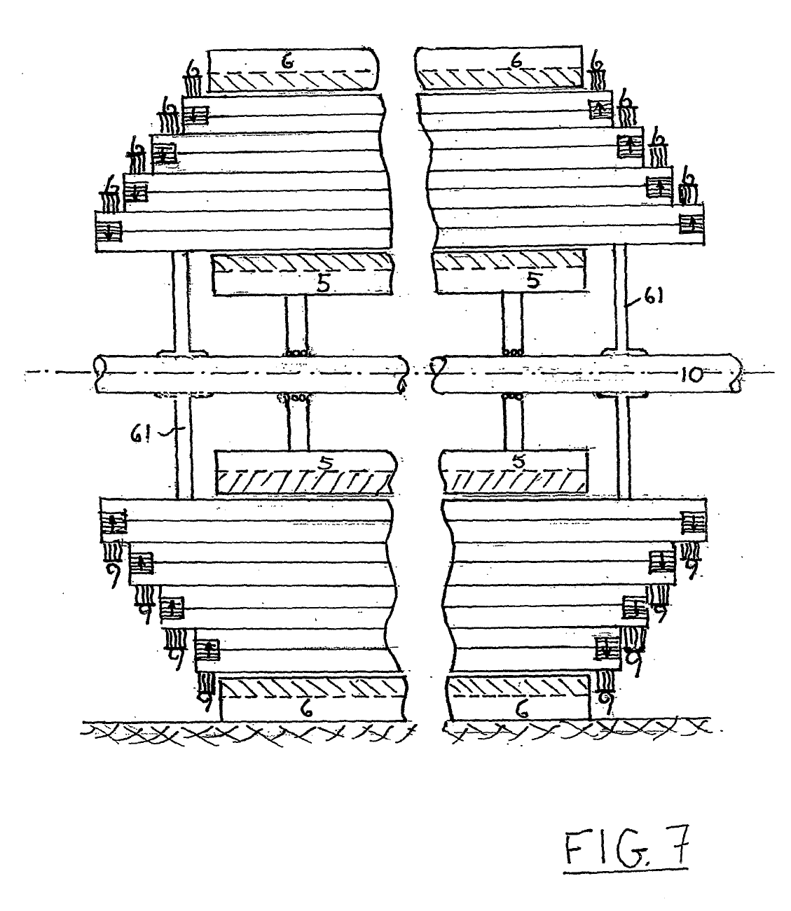

6. Machines with Slip Rings on One and Both Rotor Ends (FIGS. 6 and 7)

Comparing Radial Zig-Zags with Circumferential Zig-Zags

Numerous model calculations suggest that MP-Plus machines with circumferential zig-zags and N_{T}=2 rotors as in FIGS. 4 and 5 will be the most successful. Even so, according to the present invention, MP-Plus machines with N_{T}>2 may be readily constructed and will further increase the versatility of MP-Plus machines. Specifically, the achievable machine voltage could be increased which could be advantageous especially when rather slow rotation rates are desired. Also switching electrical connections among double rotors in a set during machine operation could effect the equivalent of “field weakening”.

One may begin with comparing radial zig-zag and circumferential zig-zag machines with an equal number of zones and rotors. In previous MP machines the total number of brush sites is A_{B}=2N_{Z}N_{T}, as seen from FIG. 1 For radial zig-zags this reduces to A_{B}=2N_{Z}, for a decrease by the factor of N_{T}. Regrettably, though, this advantage of raising N_{T} is offset by the resulting increase of rotor set wall thickness which decreases B unless also the magnet width Lₘ is increased, with the corresponding increase of magnet wall thickness and weight of the machine, as also a decrease of number of zones, N_{Z}. Thus typically, the energy density of MP-Plus machines with radial zigzags is significantly lower than of MP-Plus machines with circumferential zig-zags.

Radial zig-zags are also inferior to circumferential zig-zags in a related way as follows: The opposing fall circuits design requires only four brush sites (that can be consolidated into three brush sites) per slip ring, i.e. N_{B}=2N_{T}. By contrast, radial zig-zags require N_{B}=2N_{Z} for radial zig-zags which would typically be a rather larger number. Nor will the currents in the two cases be systematically different. Namely, together, the brushes in any one brush site have to handle the current through their respective zones, which for otherwise same dimensions will be the same for both radial and circumferential zig-zags, and which for mid-sized to large machines may require multiple “in parallel” brushes. Hence, at least in terms of total brush numbers and areas, Multipolar-Plus machines with circumferential zig-zags will be typically superior to machines with radial zig-zags.

Circumferential Zig-Zags, “Opposing Circuits” and “Mirrored Circuits” Design.

N_{T}>2 machines with circumferential zig-zags may be constructed from a multiplicity of concentric double rotors of the kind shown in lengthwise cross sections in FIGS. 6 and 7. These depict multiple nested N_{T}=2 rotor sets, together forming a rotor set of N_{T}=2N_{U} rotors if N_{U} is the number of nested double rotors. In such machines, the individual units may be connected “in series”, so as to add the voltages across them, or “in parallel” to add their currents at same voltage; or a combination of “in-parallel” and “in series” units as may be desired. Since such switching could well be done while the machine is in operation, this permits the equivalent of “field weakening” during operation.

Depending on whether slip rings are positioned at one or both ends, the overall machine geometries of opposing full circuits (see FIG. 4) can be those shown as lengthwise cross sections in FIGS. 6 and 7. For the sake of clarity, these do not show power supplies and cabling for interconnecting the units. Mirrored half circuits, however, permit only the geometry of FIG. 7.

Clearly, the most compact machine arrangement, in this case with N_{T}=8, is FIG. 6. For this construction, machines with N_{Z} zones and N_{T} rotors in the rotor set require only N_{T}/2 slip rings. The opposing fall circuits construction as in the top right inset in FIG. 4, as well as the mirrored half-circuits construction require N_{T}/2 slip rings at each end, for a total of N_{T} slip rings, as in FIG. 7.

For practical purposes, the difference in number of slip rings in FIGS. 6 and 7 is very important, not only because of the extra cost and maintenance of twice the number of brushes and slip rings but also, often even more importantly, on account of machine length. Namely, for same power and general construction, the size of the rotor and magnet tube cross section as well as the magnet tube length, mechanical support structures and the width of the slip rings will be the same for both designs. However, the extra machine length due to slip rings in FIG. 6 is (N_{T}/2)Δ, where Δ is the slip ring width, whereas it exceeds it by twice as much, i.e. by N_{T}Δ, in FIG. 7, and this can amount to a significant percentage of the whole machine length

Also of importance is the number and positioning of electrical brushes in the different designs. Specifically, the opposing full circuits geometry of FIG. 4 requires brushes in only one radial position, namely in line with the two zones generated by neighboring magnetic dipole pairs of same orientation of polarity, e.g. the 12 o'clock position shown in FIG. 4. By contract, the mirrored circuits geometry of FIG. 5 requires two radial brush positions, namely aligned with the two zone pairs of same radial orientation. In FIG. 5 these are shown in the 12 o'clock and 6 o'clock positions but they can be readily oriented in any arbitrary convenient way provided that the two brush groups remain diametrically opposed. By far less favorable still is the radial zig-zag, illustrated in FIG. 2A, that requires brushes at all zone positions, i.e. typically evenly distributed about the rotor circumference.

A further important difference between the opposing full circuits and the mirrored circuits design, especially for the case of a single double rotor, is that the latter contains two independent circuits that may be connected “in series” or “in parallel”. This makes possible the already mentioned “field weakening” effect, which in any event is possible for any multiplicity of nested double rotors.

The presence of two independent circuits in even a single double rotor with mirrored circuit design, but not with opposing circuits, causes a significant difference also in the motor current and voltage. Namely, every individual current “turn”, i.e. an axial passage along a zone between front and end of the rotor, is associated with a potential difference of V₁. Therefore in the mirrored circuits design the voltage due to one two-rotor unit is only (N_{Z}/2) V₁, while it is N_{Z} V₁ in the two-slip ring design of opposing fall circuits. By way of compensation, for same overall machine construction and same current density, the machine current in the design of FIG. 5 is twice that of FIG. 4. In deciding which of the two to choose, total machine voltage versus machine current is thus an important consideration.

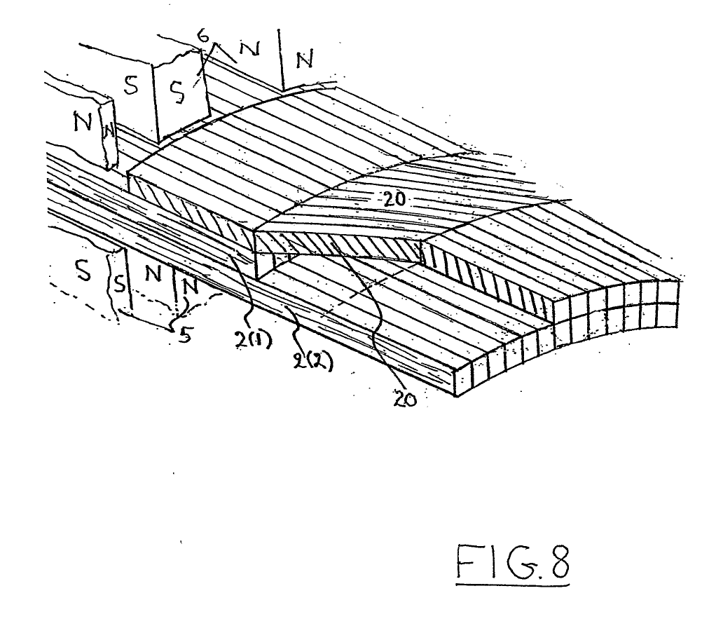

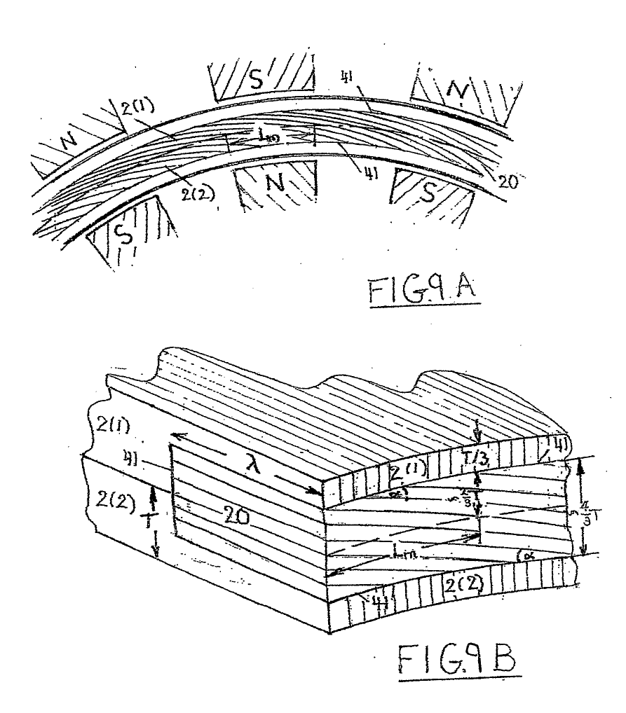

7. Construction of Flags (FIGS. 8 to 11)

“Sleeve” of Rods“(FIG. 8)

A non-trivial challenge in making MP-Plus machines is providing “flags” that electrically interconnect equivalent points in neighboring zones of neighboring rotors, and arranged such as in aggregate to establish mutually insulated current paths through consecutive zones between two selected brushes that may be separated by an arbitrary number of zones. The most straight-forward morphology is depicted in FIG. 8. Herein, as in subsequent figures, label 20 identifies the structure for electrically connecting correlated points of the two rotors, i.e. the “flags”. In this case the structure is a conical part in a terraced cylindrical kind of sleeve about the end of an N_{T}=2 rotor set. Advantageously the structure could be made of current channeling metal which, alas, is not (yet) available. In FIG. 8 the flags are envisaged to be made of the same kind of rods as the rotor, e.g. of copper or aluminum or one of their alloys, and to be glued together with an electrically insulating material such as epoxy.

The sleeve with flags 20 is attached to the outer 2(1) and inner rotor 2(2) through two cylindrical strips whose radii differ by the wall thickness of the outer rotor and which are joined by the conical middle strip that spans the radius difference between the outer and inner rotor and represents the flags (20). One of the cylindrical strips is close to the end of the outer magnet tube 6 and the other is at the end of an axial extension of the inner rotor, as shown in FIG. 5. Most importantly, (i) the mutually insulated rods of the two strips of the sleeve are individually electrically connected to the mutually insulated rods of the outer and inner rotor, respectively, and (ii) the two ends of any one rod in the sleeve are tangentially offset by the periodicity distance Lₚ, i.e. the spacing of the zones. By means of this construction, any one rod of the outer rotor is electrically connected to a corresponding rod of the inner rotor that is tangentially displaced by one zone spacing.

The one-to-one electrically conductive joining of the two ends of each flag rod 20 to the rods of the outer 2(1) and inner rotor 2(2), respectively, must be done very carefully so as not to create short-circuits either between the rods of the sleeve or between neighboring rods of the two rotors and thereby destroying the current channeling. Practical experience so far indicates that, on account of the small width of the rods, i.e. about 1.6 mm, and the stringent need to avoid short-circuits among neighboring bars, the construction of FIG. 8 will be tedious, to say the least.

“Inserts in Grooves” (FIG. 9)

Another solution to the challenge of electrically connecting equivalent points of neighboring zones in adjacent rotors in a rotor set is indicated in FIGS. 9A and 9B. In this method, that was initially used in the construction of the first rotor of Prototype II discussed in section 12 below, the end face of an N_{T}=2 rotor set is provided with a cylindrical groove (41) that is filled with current-channeling material of appropriate orientation. Channel 41 is centered on the boundary between the two adjacent rotors that are to be electrically connected, i.e. 2(1) and 2(2) in FIG. 9A. Groove 41 houses flags in the form of a packet of mechanically thin, mutually insulated metal conductors (20) that in FIG. 9A are shown as thin slanted lines. These flags connect equivalent points of neighboring zones of the two rotors in the set, i.e. 2(1) and 2(2) in FIG. 9A. The width of groove 41 should be comparable to the wall width of the rotors to be connected but not exceed twice that value so as not to intrude on the surfaces of the rotors to be connected, respectively their boundaries to adjacent rotors, if any.

In concept this “inserts in groove” method, whose geometry is further clarified in FIG. 9B, is very elegant and relatively simple. It requires forming parallel layers of thin “flags” that (i) in axial direction are parallel to the rods in the rotor, (ii) whose cross sections at right angles to the rotor rotation axis are lightly slanted against the mid-line of the rotor, and (iii) for good space filling are cylindrically curved to the radius of the rotor.

Generally one will want to place inserts (20), through which the current is transitioned between rotors, into the field-free area beyond the ends of the magnet tubes, so as to make maximum use of the magnets. However, it is considered that no harm is done when inserts are partly or even completely penetrated by the magnetic field of their respective zones, because the resulting extraneous Lorentz forces will be substantially in radial orientation and thus will not interact with the machine rotation.

In order to minimize the electrical resistance of the current transition from one zone in one rotor to a neighbor zone in an adjoining rotor, the axial depth of the groove, λ, may be chosen accordingly, even while in order to minimize machine length one will want to keep λ small. Quantitatively, with p the resistivity of the material of the rotor and of the conductive insert material, the resistance due to the inserts per zone and single transition from one rotor to the other, i.e. from rotor 2(1) to 2(2) in FIG. 9B, is approximately
R_{λ}≅ρ[λ/2kTLₘ+Lₘ/(1-k)Tλ]
Herein the first term is the resistance of the reduced thickness kT of rotor wall (in FIG. 9B assumed to be k=⅓) that adjoins the insert and feeds the current into it over its axial length of λ, and whose cross section per zone is kTLₘ. The factor ½ in the first term of eq. 1 arises because, on average, this part of the rotor wall is traversed by only one half of the current transferred. The second term of eq.1 is the resistance within the insert. Namely, disregarding the factor cos cc on account of the inclination of the conductors relative to the rotor circumference, each current line spans the distance of 2Lₘ in the insert, while only one quarter of the insert's cross section of 2(1-k)Tλ carries current between any two zones. This is so because one half of the insert electrically connects spaces between zones, and the current carrying material makes equal electrical connection between a zone and both its two neighbor zones in opposite directions.

Quantitatively, we find the radial insert width of minimum electrical resistance, λₘᵢₙ, through differentiation in the usual manner as
(dR_{λ}/dλ)ₘᵢₙ=1/(2kTLₘ)−Lₘ/(1-k)Tλₘᵢₙ²=0 i.e. λₘᵢₙ/Lₘ=[2k/(1-k)]^{1/2}
For k=⅓ as in FIG. 6B, this yields λₘᵢₙ=Lₘ, for k=0.2 it is λₘᵢₙ=0.71Lₘ and for K=½ it is λₘᵢₙ=1.4Lₘ. Thus inserts of ½ Lₘ to Lₘ depth are reasonable, and according to eq.1, add only modestly to the overall machine resistance.

In order to achieve this structure in practice, in the course of constructing prototype II (see section 12 below), flags 20 in the form of rectangular copper foil pieces (resembling flags, whence their name) were assembled and epoxied together into current-channeling packets which were shaped into “inserts” outside of the machine. These were then glued into groove 41, using insulating epoxy at the bottom of the groove and conductive epoxy at the cylindrical walls of the groove.

Perhaps on second try and with the benefit of practical experience, the discussed “inserts in grooves” method can be made to work. As it was, the conductive epoxy used was too highly conductive and too fluid, and the fit between the inserts and cylindrical groove walls was not tight enough. As a result, the current short-circuited parallel to those cylindrical walls.

“Flags Between Poles” (FIG. 10)

Following the disappointment with the “inserts in grooves” method in the case of prototype II, the groove 41 was filled in with insulating adhesive and the “flags between poles” method was devised as illustrated in FIG. 10. Herein, holes (151) in axial direction and centered on the insulating bonding layers (57) between pairs of neighboring rods (150) are drilled from the rotor end as indicated in FIG. 10B. Into these, metal “poles” (152) are glued conductively. “Flags” (20) are conductively glued or soldered between pairs of poles (152) that are in equivalent radial positions relative to magnets 5 and 6 but in neighboring zones on opposite rotors, i.e. one on rotor 2(1), the other on rotor 2(2). Thus the flags can carry the current between the two rotors 2(1) and 2(2) always from one pair of neighboring rods on the outer rotor to the equivalent rod pair on the inner rotor, but circumferentially displaced by one zone periodicity (i.e. magnet plus gap spacing) distance

As it turned out, in clearing out and re-filling the previous groove, small amounts of conductive epoxy that had flowed into the flat annular bottom of groove 41 had remained undiscovered. This conductive epoxy caused several isolated spots of short-circuiting. The approximate locations of those short circuits could be located in the testing phase of prototype II, but at that stage could not be eliminated. As a result prototype II, as fitted with “flags between poles” rotated on voltage application with a speed that at no load increased with voltage much in accordance with expectations. Also the rotation reversed on reversal of current polarity. These results virtually prove the concept and construction of MP-Plus machines. However, as would be expected under the circumstances, namely that with increasing voltage an ever rising share of the current would bypass the zones via short-circuiting paths, the machine currents rose unduly fast with machine voltage and the machine torque was much too feeble.

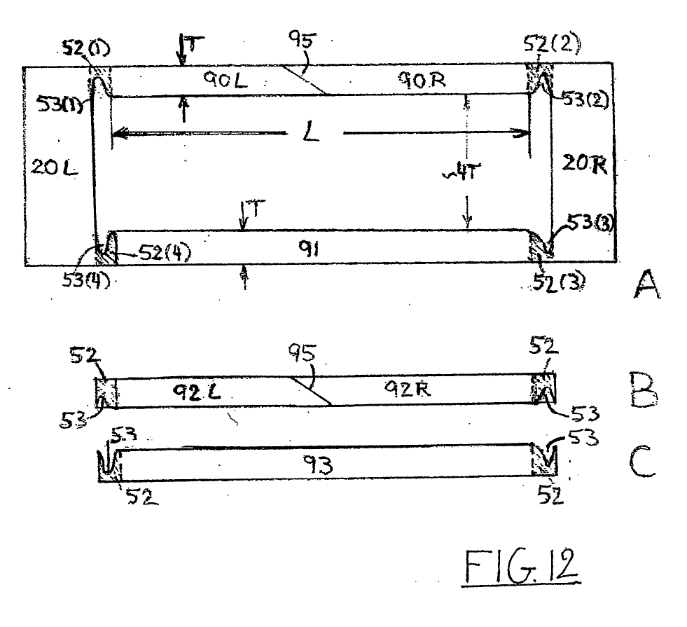

“Flags Between Tabs” (FIG. 11)

The “flags between tabs” method, illustrated in FIG. 11, is somewhat related to the “flags between poles” method of FIG. 10. Herein poles 152 in holes 151 are replaced by “tabs” 153 that are conductively fastened to the cylindrical surface of rotors 2(1) and 2(2), and flags 20 are conductively joined to these, as indicated in FIG. 11. The tabs (153) may straddle, and thereby conductively join, more than two neighboring rods 150. This is possible because the tabs are outside of the magnetic field, in fact may optionally collectively form a slip ring, so that eddy currents are not an issue. Four or five flags per zone will be sufficient to prevent significant current fluctuations as well as straying of current out of the zones. Manufacturing costs are reduced by the corresponding reduction of the number of flags. The detailed shape of the tabs and their extensions to which the flags are attached are optional.

As a variant of this method, the tabs may be inserted in lieu of insulation between adjacent rotor rods at their ends. The disadvantage herein is that essentially all rotor rod ends will have to be pair-wise joined by tabs that conduct current into and out of them equally, while those rod pairs will have to remain mutually electrically insulated. By contrast, tabs on, or forming sections of, slip rings may cover four or five rods.

8. Mass Production of Medium-Sized to Large MP-Plus Machines (FIGS. 12-16)

Motivation and Basic Considerations on Geometry and Dimensions

The present invention provides a simpler and more cost effective method of making Multipolar-Plus machines with circumferential connections than by means flags in their different forms, namely through the stacking of suitably shaped metal sheet or foils into rotors of otherwise much the same geometry in accordance with FIGS. 12 to 16.

In the new method, according to the present invention, the rotor is constructed through assembling shaped pieces of thin metal sheet or foils as clarified in the following explanation and figures.

Experience gained in making two prototypes, one of them discussed in section 12 as already mentioned, has brought home the potential advantages, if not perhaps the economic necessity, of automating the production of N_{T}=2 rotors for MP-Plus machines, which otherwise might require an undue amount of tedious handwork. According to the present invention, such automation will favorably be based on making rotors from modules of limited radial extent and assembling these into complete rotors.

Rotor modules shall be made by stacking together shaped pieces of metal sheet or foil, dubbed “R-units”. According to the present invention, preferably the production of rotor modules begins with making blanks of R-units and strips, as shown in FIGS. 12A, 12B and 12C, and in the cases of FIGS. 12A and 12B making cuts (labeled 95) through them. The preferred materials for strips and R-unit blanks shown in FIG. 12 are metals of high electrical conductivity, low weight and at least moderate mechanical strength, such as for example copper or aluminum, and the desired shapes could be stamped and/or cut from metal sheet, strips or foil.

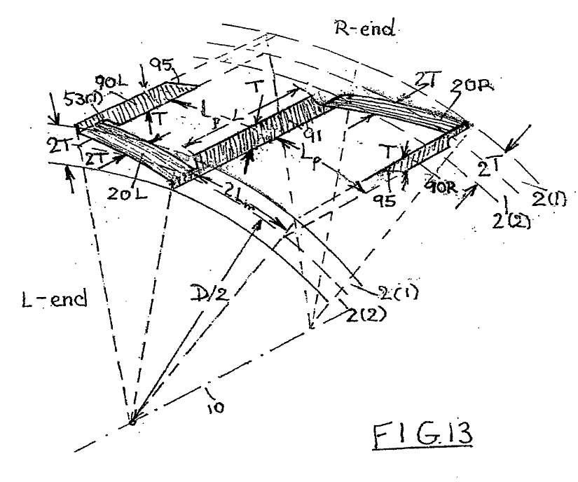

Cuts 95 separate the upper part of the R-unit blank in FIG. 12A into two, labeled 90L and 90R, and the strip shown in FIG. 12B into pieces 92L and 92R. Together both of these pairs of parts are similar to strip 93 shown in FIG. 12C. In turn, these pieces are geometrically similar to part 91 in FIG. 12A. In course of the manufacturing process further explained through FIGS. 13 to 16, pieces of same shape will be laminated together with an insulating adhesive, except at shaded regions 52 where they are to be glued conductively. Collectively, parts 90R and 90L, and 92R and 92L will ultimately form inner rotor 2(2), while parts 91 and 92 will form outer rotor 2(1), and parts 20L and 20R will form flags connecting correlated points of the two rotors.

As in the previous discussion of flags herein, pieces 20L and 20R will make flags that connect rotors 2(1) and rotor 2(2) in a large multiplicity of points, i.e. at least three and favorably four or more points per zones. Again, the electrically connected points between rotor 2(1) and 2(2) shall be circumferentially displaced by the periodicity distance among zones, i.e. by the circumferential distance of Lₚ (typically equal to 2Lₘ), where Lₘ is the circumferential magnet width as projected on the rotor mid-line.

Regarding probable dimensions the following: Dimensions of MP-Plus machines will vary widely, e.g. between rotor diameters of less than D=3 cm for machines made by winding of wires in accordance with the next section to, say, more than D=3 m for large machines in the tens to hundreds of MW power range. Machine lengths may similarly vary widely, e.g. between at least 3 cm and 3 m. Even so, the wall thickness, 2T, of N_{T}=2 rotor sets for MP-Plus machines will be rather more restricted, namely between, say, ½ cm and 6 cm. This is so because the weight-to-power ratio of MP-Plus machines decreases with decreasing rotor set wall thickness, and the practical lower limit of rotor wall thickness is given by the mechanical rotor strength to support the motor torque. This will rarely, if ever, demand wall thicknesses above 2T˜6 cm.

Further, while the optimal relative sizes of, and arrangements between, the magnets has not yet been precisely determined (see section 3: “Alternative Magnet Configurations”), it is likely to be such as to let Lₘ, the projected circumferential length of the magnets on the midline of the rotor, be similar to the rotor wall thickness, 2T, plus the clearance, λ, between rotor and magnets on the outside and the inside. Further, the circumferential separation between the magnets will be similar to Lₘ. Thus Lₘ≅2T+2δ, and the periodicity distance between zones as projected on the rotor mid-line is approximately Lₚ=2Lₘ=4T+4δ. In turn the clearance ranges between an estimated δ=½ mm for the smallest machines and δ=5 mm for the largest.

Given the indicated dimensions, 3 (three) strips 92 and 93, will on average be needed between any two neighboring R-units in both rotors. A correction may have to be made to compensate for the diameter difference between outer and iuner rotor. Fortunately, the thickness of glue layers between neighboring strips and conductors, while individually rather smaller than the average thickness of the R-unit and strips of FIG. 12, will cumulatively amount to at least several percent of the rotor material, making macroscopic length dimensions somewhat adjustable. Thereby any unduly severe constraints on dimensional accuracy will be relieved. In any event, the option remains of inserting or removing some extra strips on the outer and inner rotor side, respectively, or of making the cross sections normal to the plane of the drawing of the pieces in FIG. 12 mildly wedge-shaped to adjust for the different radii of rotors 2(1) and 2(2).

Much more importantly, the need to suppress eddy currents places an upper limit on the thickness of R-units and strips. Past experience (i.e. with Prototype I, of MP type with a multitude of brushes) has shown that suppression of eddy current requires w≦˜ 1/16″≅1.5 mm. Further, in order to prevent the current from significantly bypassing the zones and thereby degrade the machine torque, it should favorably be w≦˜Lₘ/8 while Lₘ/5 may be acceptable.

For the production of rotors, R-units and strips must be bonded together by means of electrically insulating layers, except at areas 52 in FIG. 12 where the connections have to be electrically conductive. The choice of bonding and, if a glue, its method of application are optional. Ordinary epoxies have been found useful for insulating bonds, such as needed for the suppression of eddy currents, and conductive bonds (e.g. epoxies filled with metal powder or spot welds) may be used for conductive joints. Adhesives may be applied to one or both sides of the joints, may be applied in the form of foils that cause bonding at raised temperatures, or they may be applied through a wide range of methods, including dipping, spraying, brushing or wiping, and they may be chosen to set on contact or after curing at elevated temperature, or a combination of both.

While overwhelmingly the bonds among R-units and strips shall be insulating to inhibit eddy currents and to permit the current channeling on which multipolar machines depend, strips must be conductively connected to the correlated R-units in the shaded areas marked 52(1) to 52(4) in FIG. 12, that adjoin the notches 53(1) to 53(4). Such conducting connections are needed to permit low-resistance current flow between the conductors in R-units (i.e. parts 90 and 91), strips 92 and 93, and adjoining conductors 20, i.e. the flags. However, any R-unit plus attached strips shall be electrically insulated from neighboring R-units and attached strips so as to inhibit circumferential current flow between R-units since this would permit bypassing the zones with their high magnetic flux density, and thus would degrade the Lorentz force and resulting machine torque.

Bending and Completion of R-units

Preferably, multiple blanks for R-units will be stamped out of continuous rolls of sheet metal, and strips 92 and 93 could be formed from the otherwise wasted material between parts 90 and 91 of the R-units. The order in which strips 92 and 93 will be attached to R-units, as compared to their bending into shape in accordance with FIG. 13, as further explained below, is optional In any event, the result shall be a supply of shaped R-units ready to be assembled into “rotor modules” from which rotors may be constructed, as follows.

In line with the preceding discussion, before assembling into rotor modules, the R-units must be bent into the shape indicated in FIG. 13, namely through bending parts 20L and 20R. As already indicated above, these will become the flags, i.e. the conductors between the two rotors, 2(1) and 2(2). In terms of FIG. 13 the conduction will be on the left and right end, such when a current arrives at the L-end of the R-unit at the outer rotor 2(1), it will be transferred to the left end of the inner rotor 2(2) via 20L, travel to the right end of the inner rotor via 91 and back to the outer rotor, on its right end via 20R. As may be seen, by stacking such R-units into a full cylinder, the described current path will comprise current traverses from inner to outer rotor and back such that the current direction is reversed on each axial passage through strips 90 and 91, e.g. always from left to right in the inner rotor and from right to left in the outer rotor. Thus in all zones the resulting Lorentz force will have the same sense of rotation.

Proper operation of Multipolar-Plus machines will depend on the accurate placement of zones and brushes as well as uniform construction of the R-modules. The goal is that along the whole extent of any one current path between “in” and “out” brushes, that depending on machine construction may comprise one hundred zones or more, the current passes through (nearly) equivalent spots in all zones, so as to generate Lorentz forces over its entire length,. Any part of a current path between “in” and “out” brushes that strays outside of the intended zones will not generate a torque in a motor, or current in a generator, and thus will be wasted. Worse yet, the entire current path will be disabled if by some inaccuracy it fails to touch both the “in” and “out” brush.

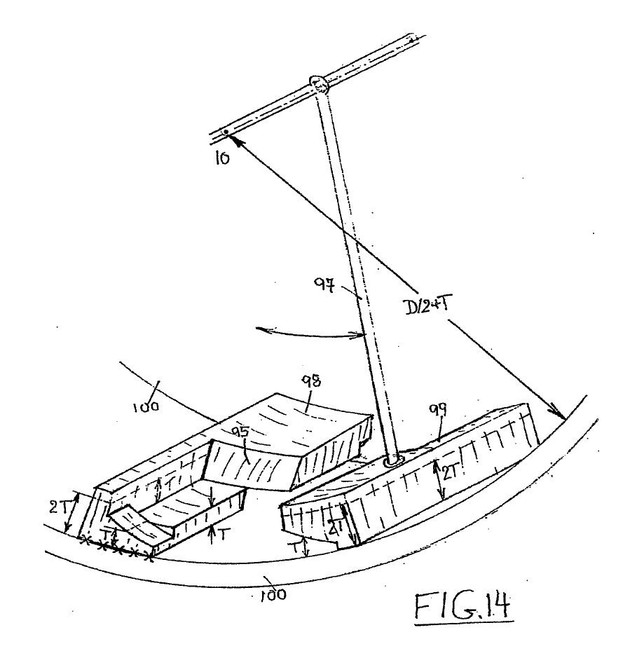

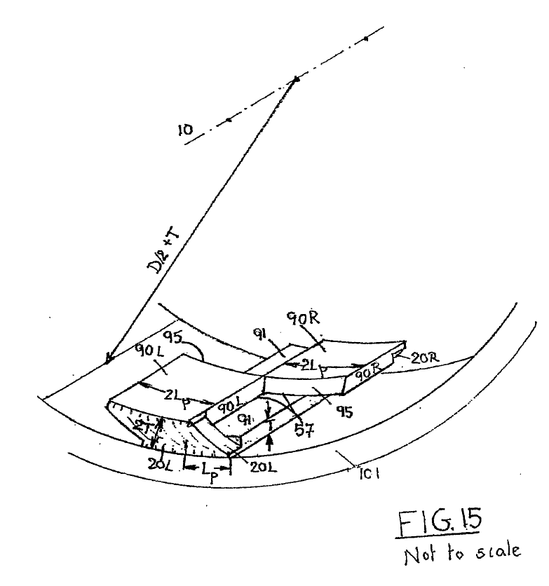

While in FIG. 13, parts 90R and 90L that are separated by cut 95, form part of the outer rotor 2(1), this is an arbitrary choice and the reverse is equally possible. In fact, in FIGS. 14 and 15, the cuts are placed on the side of the inner rotor.

Assembly of R-units into R-Modules

In view of the many R-units that will be required for even small, let alone large machines, rotor manufacture shall be automated as much as possible. According to the present invention this is accomplished by means of an apparatus that is schematically depicted in FIG. 14. It is designed for speed as well as for high accuracy in terms of precise cylindrical rotor shape (without undue “run-out” that would cause rubbing/scraping of the rotor against the inner and/or outer magnet tubes), and accuracy of the electrical connections between outer and inner rotor. hi line with the explanation above, accuracy is critical for insuring that every transition of the current between the two rotors, displaces the current path by one periodicity distance Lₚ=2Lₘ, so that a current that flows between any two brushes on different zones will pass from zone to zone, rather than perhaps intermittently wander into intervals between zones or miss the “out” brush, to the great detriment of machine efficiency.

In FIG. 14, 100 is a cylindrical shell whose inner surface conforms to the intended outer surface of the rotor to be manufactured, having diameter D+2T+δ where D/2 is measured from rotation axis (10) to mid-line (4) of the rotor, and δ is the clearance between rotor and magnets.

Mold parts 98 and 99 are designed to form R-unit blanks into the intended shape.

Both, shell 100 and mold parts 98 and 99, may be made of any suitable material, not necessarily the same for all, e.g. a metal, plastic, ceramic or composite. Also, mold parts 98 and 99 and shell 100 could be supplied with means of heating to some predetermined, controlled temperature, e.g. for stress-relief annealing of the material, for hardening the adhesive joints between the parts, and/or other purposes but, if so, with close regard to controlled dimensions.

Mold parts 98 and 99 in FIG. 14 are shaped such that when placed together they define the shape of a bent R-unit as depicted in FIG. 13 except that, as already indicated, here cut 95 is on the inside of the rotor. This inversion demonstrates that the placement of cut 95, including also positioned relative to its axial positioning, i.e. near the center or axially displaced in either direction, is arbitrary. In FIGS. 13 and 14, the detailed position of cut 95 was chosen not so much for technical reasons than for simplicity and clarity of the drawings.

Swing arm 97 in FIG. 14 permits sliding of movable mold part 99 so as to periodically close and open the gap between 98 and 99, as one by one R-unit blanks, or optionally already shaped R-units, are fed into the apparatus and compacted onto the growing stack. On account of the cylindrical synunetry, single or, optionally, multiple R-units may at one stroke be placed between 98 and 99. The number of simultaneously inserted units is highly adjustable. Larger numbers are possible for groups of R-units that already have an appropriate wedge shape that otherwise would have to be imposed by compression, e.g. of still pliable insulating adhesive.

R-units may be fed into the gap between fixed mold part 98 and movable mold part 99 by pushing them in from one end, e.g. the far end in FIG. 14, or perhaps better by reaching in with an automatic arm from the near end to pull R-units into position one by one. Since for the suppression of eddy currents the thickness of the individual R-units will be w<˜ 1/16″ and the rotor dimensions will typically be much larger, it may be possible to achieve the desired assembly without imparting the discussed wedge-shape to the R-units, namely simply by allowing the glue layers between the R-units and strips to be somewhat thicker on the outside than the inside. Alternatively, one may adjust the number of strips 92 and 93, e.g. by periodic-ally inserting an extra strip between parts 98 and 99 on the outside, or optionally one may make already the R-unit blanks mildly wedge-shaped, or one may make 92- and 93-type strips of different thicknesses.

How many R-units will be stacked and fused together in the machine of FIG. 14 to form one rotor module is optional. Advantageously according to the present invention, the circumferential dimension of R-modules will optimally be 4Lₚ as indicated in FIG. 15. Namely, this is the largest size of R-module that can be made without the need for conductively gluing or soldering together the two sides of cut 95. For the sake of clarity, in FIG. 15 the somewhat complicated shape of an R-module of 4Lₚ circumferential extent is shown not to scale. Namely, with typically Lₚ=4T, and with the T/D value chosen in FIG. 15 large enough to show the curvature effects, and T chosen large enough to show the detailed geometry of the section, a 4Lₚ=16T section would extend over almost 60° angular range and the geometry of the unit would become confused. On the other hand, from a practical standpoint, the large angular extent of 4Lₚ sections is a considerable advantage in the construction of large machines. For example a 37 Mw machine with a D=2 m diameter rotor of 2T=5 cm wall thickness would comprise in the order of 1000 R-units and would be assembled from, say, 36 R-modules.

Assembling R-Modules into a Double Rotor

According to the present invention, R-modules are advantageously assembled in a cylin-drical shell 101 of radius D/2+T (see FIG. 15) and arbitrary circumferential angular extent α. However, πD/Lₚ must be an integer within, say, 1% or better, so that a whole number, in general N_{sect}, of R-modules generate a complete double rotor with good accuracy. Preferably but not necessarily, an initial assembly of R-modules might comprise N_{sect}/2 sections, or N_{sect}/3 sections, or in general N_{sect}/j sections, with j a reasonably small whole number, so that a complete rotor can be made by assembling j such rotor section assemblies.

The accuracy of shape of shell 101 is critical, as was that of shell 100, since these largely determine the accuracy of the cylindrical shapes of the inside and outside surfaces of the finished rotor, and thus should assure the smooth rotation of the rotor in the gap between the outer and inner magnet tubes.

The rotor sections of a desired number of R-modules, that each advantageously would comprise a maximum circumferential extent of 44 as argued above and depicted in FIG. 15, would be assembled by using electrically insulating glue except along the location of the two sides of cuts 95, indicated in FIG. 15. Here the connection must be made with a conductive glue that should be applied thinly for minimum resistance in axial direction but high resistance in circumferential direction. This is required in order to minimize conduction in the conductive glue material along 95 that would permit a fraction of the currents in each “turn” to stray out of the zones and into the B-field-free gaps between zones where the resistance in axial direction is lowered and no Lorentz forces can be generated. In order to facilitate this goal and at the same time to enhance the mechanical strength of the bond along cut 95, FIG. 15 shows the cut to be slanted into a conical shape relative to the axis direction 10, whereby the bonded area has been increased. If experience should suggest that the proposed conical shape of 95 does not offer sufficiently high electrical circumferential resistance, other more complicated cut shapes, e.g. crenellated, could be used. However, this is thought to be a rather unlikely need.

Bonding among R-modules of the type illustrated in FIG. 15 is expected to be particularly strong on account of their interlocking shape, e.g. the gluing together of the respective 91, 90L and 90R parts of one R-module with the matching ones of the next R-moduklen. This at the same time relieves the mechanical stress on the conductive glue joint at 95.

Completion of MP-Plus Machines

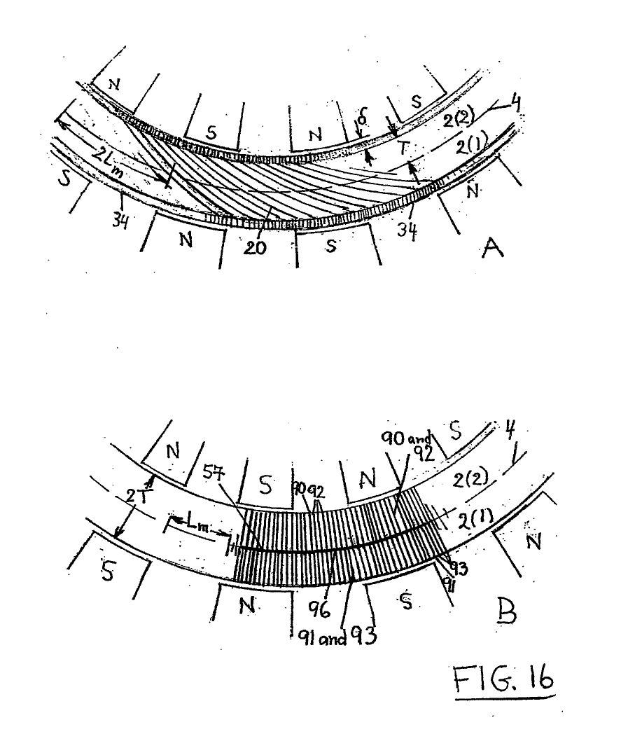

After assembling R-modules, a cross section of an N_{T}=2 rotor near either of its ends would look much like FIG. 16A. Herein, for clarity, positions of the magnets in the inner and outer magnet tubes are indicated, even though the magnets extend axially only between the inner edges of the conductive joints between bars and parts 90 and 91 that are clarified in FIG. 12. In other words, the conductive connections between rotors 2(1) and 2(2) that are formed by parts 20L and 20R which serve as flags, are positioned in field-free space beyond either end of the magnet tubes and thus will be automatically free of eddy currents. By contrast, a cut through the rotor inside of the magnet tubes would show the pattern of FIG. 16B. Here the zones between the magnet poles will have a magnetic flux density of B, whereas the gaps between the zones will be substantially field-free.

Depending on specific construction, as seen in the insets of FIGS. 4 and 5, one or two slip rings 34 may be made, namely on the outside surface of one or both rotor ends that project outside of the magnet tubes, i.e. that on their inside comprise conductors 20L and/or 20R, as indicated in FIG. 16A. Given shells 100 and 101 were of high quality, to complete slip rings 34, nothing further may be needed but to provide a surface polish as through some fine emery paper. Otherwise a fine cut on a precision lathe may be required to assure as small a run-out as may be reasonably possible, because electrical brush wear rises with magnitude of run-out. Additionally, for low electrical brush resistance or protection from chemical attack, a gold or other noble metal plating may be provided.

The remaining construction of MP-Plus machines according to this invention will be conventional, and similar to, or the same as, previously disclosed and demonstrated in Prototypes I and II (see section 12 below).

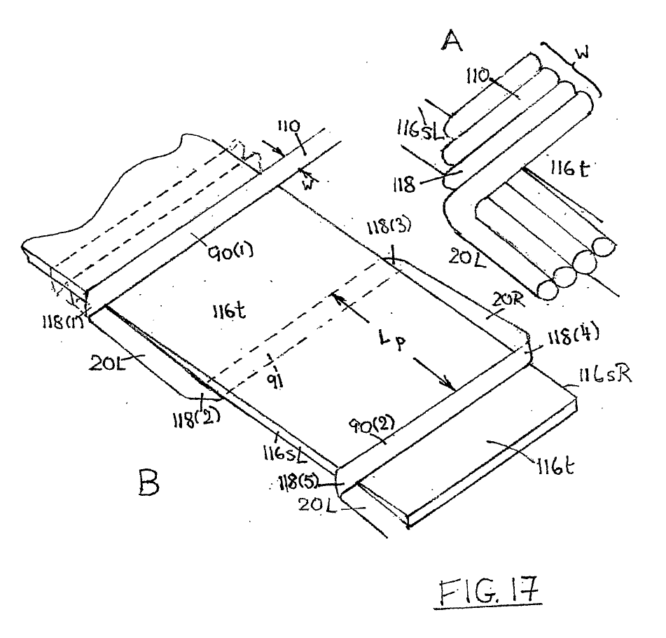

9. Making Small MP-Plus N_{T}=2 Rotors Through Winding Wires (FIGS. 17-19)

Motivation

Below some limiting lower size, the mass-production method outlined in section 8 will be unusable. Similarly there is a lower size limit on all actual or previously proposed methods of making rotors for MP and MP-Plus machines based on the assembly of stiff rods, bars etc. that are bonded together, parallel to the rotation axis, with intervening electrically insulating layers for the suppression of eddy currents. That construction can be scaled up to any desired machine size, e.g. rotors of D=3 m diameter. However, it cannot economically be downsized below, say, D=10 cm, and thus is out of range for electromotors suitable for wheel chairs, car windows, vacuum cleaners and toy cars, for example. To fill in this gap, according to the present invention, small MP-Plus machines based on N_{T}=2 rotor sets with circumferential zig-zags can be made through suitable winding flexible metal wire ribbons onto a “rotor center sheet”. By this method, MP-Plus rotors at least as small as D=3 cm and probably smaller could be produced, thereby opening the Multipolar Plus market to a large variety of small electric machines.

Except for items to which no label was as yet assigned, the labels used in FIGS. 17 to 19 below are the same as in the other figures herein

Making a Rotor through Winding Wire Ribbons onto a “Rotor Center Sheet”

A preferred embodiment of rotor manufacture according to the present invention is outlined in FIGS. 17 to 19. Herein 110 is a metal ribbon composed of multiple similar parallel wires that are bonded together with insulating coating of plastic, epoxy or other adhesive, e.g. four wires in FIG. 17A. Wire ribbon 110 is wound onto a rectangular flexible “rotor center sheet” 116 whose length equals or exceeds the rotor circumference and whose width equals the length of the intended rotor.

FIG. 17B is a schematic, perspective view of the winding set-up. Metal ribbon 110 is wound onto rotor center sheet 116 whose large surfaces 116t at the top and 116b at the bottom (not seen) are covered with an insulating contact glue such that on completion of the winding operation, the ribbons are stuck to the rotor center sheet and, with it, form a somewhat flexible unit. Also at least one side of the ribbon may be supplied with adhesive, so as to glue together parts 20, the ribbon sections that project out from the sides of rotor center sheet 116, in their transit between the 116t and 116b sides, and are deposited in successive windings. Preferably the ribbon should be made of a highly electrically conductive as well as mechanically strong metal. Copper may be the best choice, although on account of weight and corrosion resistance, also other metals may be chosen, such as silver or aluminum.

Ribbon 110 is made of a multiplicity of parallel wires, each of no more then about 1/16″ diameter in order to inhibit eddy currents. The wires are bonded together with an insulating coating in the style of computer ribbons. However, since ribbon 110 will have to be formed into a crisp, shape-retentive geometry, including 90° folds (118, illustrated in FIG. 17A), and since in small machines the voltages will tend to be small, the coating layers could be quite thin.

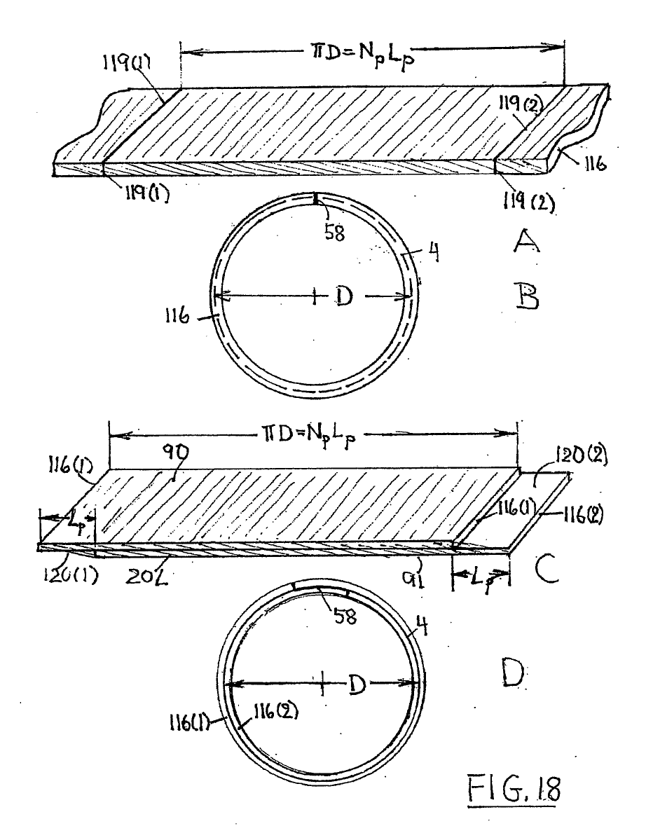

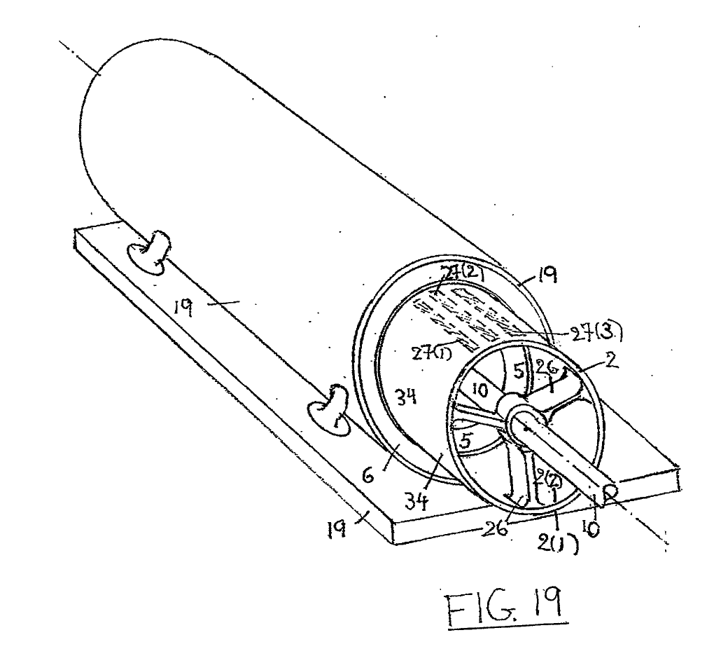

As illustrated in FIG. 17B, the ribbon lies flat on the large surfaces of the rotor center sheet where it is labeled 90 on the top side (116t) and 91 on the bottom side (116b, not seen). After the rotor winding is completed by filling in all available spaces, it is cut to size as may be needed. Next, bending the rotor center sheet into a cylinder to form the double rotor (2), parts 90 and 91 will form the outer 2(1) and inner 2(2) rotor, respectively, as depicted in FIG. 18B. However, on the two narrow sides, labeled 116sL and 116sR, ribbon 110 projects outwards, where it is labeled 20L and 20R, as shown in FIG. 17B but only lightly indicated in FIG. 18.

In later use, parts 20 on the left (20L) and right side (20R) of rotor center sheet 116, transfer the current between its top and bottom sides, i.e. what will become the two rotors 2(1) and 2(2), respectively. The displacement of the windings between the top and bottom side of the rotor center sheet, due to parts 2(1) and 2(2), and thus the resulting eventual displacement of the current path between rotors 2(1) and 2(2) in the later machine, is by one periodicity distance, Lₚ of the zones This typically equals twice the magnet width Lₘ in the magnet tubes as projected on the midline of the rotor, i.e. typically Lₚ=2Lₘ. Adhesive applied to at least one side of ribbon 110 will bond the 20L and 201R layers within themselves, but these should preferably not be bonded to the sides of the rotor center sheet.

Optionally, instead of making windings as in FIG. 18A and 18B, rotor center sheet 116 may consist of two similar separate layers 116(1) and 116(2) on which the wire ribbon may be wound with loose loops on both sides. The wire length in these loose loops should have a length that permits shifting 116(1) and 116(2) relative to each other by Lₚ, as indicated in FIG. 18C. In that method, care must be taken that the wire ribbon parts in the resulting parts 20L and 20R lie flat, i.e. their wide faces parallel to 116t and 116b.

The discussed geometry of the ribbon lying flat not only on both large surfaces of sheet 116 but also extending sideways on the narrow sides 116sL and 116sR in the same ribbon orientation, is accomplished by means of 45° folds (118). FIG. 17A shows one such 45° fold in detail.

Note in FIG. 17B that the displacement between successive ribbon “turns”, i.e. between layers 90(1) and 91, is 2Lp, consistent with the geometry of parts 20L and 20R that each generate a displacement by Lₚ. The gaps between successive turns of the ribbon in one winding, i.e. between the turns 90(1) and 90(2), of width 2(Lₚ-w), have to be filled in with additional similar windings of ribbon 110. The broken lines to the left of 90(1) in FIG. 17B indicate the position of the adjacent two turns of wound ribbon. Thus there will be a total of 2Lₚ/w windings to complete the rotor, and for proper space filling without gaps and overlaps this must be a whole number, say, Nₚ. Good accuracy of winding is necessary so that in the future machine, every current path will complete its course, perhaps extending through a hundred or more zones, through closely equivalent points, e.g. at the left zone edge, or the zone mid-point, etc. Even so, with four, or preferably five or more ribbon widths per zone, as already discussed in connection with FIG. 17, the demands on the accuracy of placing the individual winding turns are locally somewhat relaxed e.g. to, say, up to one half a ribbon width, or so. In actual practice, this relax-ation of accuracy will be possible on account of the anticipated modest extendability and compressibility of the wire ribbon across its width, and it will presumably lower production costs.

The rotor center sheet, or more precisely its mid-line, shall be made of, or after winding be cut to, length πD where D is the rotor diameter, and bent into a cylinder to form the rotor. This may be done in two ways: Either, the center sheet is made suitably longer than πD and the ribbon windings are extended over a length of at least πD+Lₚ. Thereafter the rotor center sheet with its windings is cut parallel to the wires in two places 7cD apart (very closely amounting to an exact number of periodicity distances as already indicated) such that the length of both large surfaces is covered with windings as in FIG. 18A. The thusly generated cuts, 119(1) and 119(2), on the two ends of what is going to be the rotor, are then joined butt-ended by means of soldering, an electrically conductive glue (58), or some other suitable means of electrically conductive joining. This will result in a cylindrical rotor with an axially oriented seam where the cut was closed as indicated in FIG. 18B. Alternatively the cut and rejoining may be made at any other desired angle, followed by suitable rejoining.

Alternatively, as already introduced above, the rotor center sheet 116 may be made from two similar layers that after ribbon winding are relatively displaced by distance Lₚ in radial direction relative to the later rotor. In this alternative method, the result will be a rotor center foil as indicated in FIG. 18C whose large surfaces are covered with windings of label 90 and 91, and with wire ribbons in the form of layered strips of labels 20L and 20R projecting from the sides, wherein the large ribbon surfaces are nearly parallel to those on sides 116t and 116b, as already discussed. The bending of the rotor center sheet with its windings and layered side strips, and the joining of the exposed surfaces 120(1) and 120(2) at its ends, by means of a conductive adhesive, will then complete rotor 2 as illustrated in FIG. 18D.

The disadvantage of the first method of FIGS. 18A and 18B is the need for making precise cuts that will permit accurate joining of the correlated wound ribbons that have been cut at the two ends. The disadvantage of using two relatively displaced center rotor sheets, 116(1) and 116(2) in accordance with FIGS. 18C and 18D, is the loss of electrical connections between the two ends of the sideways extension (20) at the axial seam where the cut was glued shut. These electrical connections must be established since the effect would otherwise be very serious, namely the interruption of many if not all current paths about the rotor circumference. Thus those connections must be made by one means or the other, not necessarily precisely between wires, but certainly between ribbons; and as nearly as possible, none may be left out.

In either method, bending together of the compound consisting of rotor center sheet and windings should result in a rather uniform cylinder, although the joining operation with the resulting seam will necessarily introduce some irregularity that may or may not be significant. In any event accuracy of construction is needed in order to avoid later scraping of the rotor against inner and/or outer magnet tube when operating the fully assembled machine (FIG. 19), as well as reducing “run-out” of slip rings 34 at one or both ends. To this purpose, measures may have to be taken to assure roundness. One means herein will be supports 26 indicated in FIG. 19, by which rotor 2 is rigidly fastened to machine axle 10, and by means of which the Lorentz force generated in the rotor is translated into machine torque. Also, one may place an end cap or end ring on either or both ends of the rotor (2), not shown in FIG. 19.

Rotors for small MP-Plus machines of N_{T}>2 may be constructed in the form of multiple nested N_{T}=2 rotors made by the discussed wire winding method, in the manner illustrated in FIGS. 6 and 7

Numerical Considerations

As already indicated, the width of the ribbon (w, as shown in FIG. 17A) should best comprise five or more wires, and at a minimum three. This is needed for uniformity of current conduction across the zones and to avoid undue current “ripple” in operating the machines. Also, as a matter of practicality, parts 20 need to have adequate space, which essentially requires the ratio of width to thickness of the individual wire ribbons to be at least three and more safely equal to or larger than four. Lastly, machine efficiency very sharply decreases when brushes are wider than the zones, and similarly when increasing ribbon width causes an increasing fraction of ribbons to partly extend beyond zone edges. This is so because, effectively, generation of Lorentz force work translates into increased electrical resistance. Thus in machine operation, ribbons protruding beyond zone edges represent paths of lowered electrical resistance that act to short circuit the desired current path.

Viewed differently, when magnets cover about ½ of the rotor circumference as generally assumed, the decrease of the Lorentz force on individual ribbons due to their finite width is on average somewhat less than 50%, the same as for individual wires. However, due to the successive 45° turns (118) leading and trailing edges of the ribbons are reversed between the outer and inner rotor, i.e. between 2(1) and 2(2). In any event, the motor efficiency is approximately proportional to Lₚ/w−½=2Lₘ/w−½. Hence a w=2Lₚ wide ribbon would cover two neighboring zones, causing as much clockwise as anticlockwise Lorentz force over its width for net zero torque. Correspondingly, w should be small, but its minimum is w=d=T, i.e. the wall thickness of rotors 2(1) and 2(2). This in turn should empirically be T<≅½Lₘ for B>0.65 tesla. As a result, say, four wires per ribbon and Lₘ/w≅2.5 tend to be acceptable and more would be desirable.

As an example of an MP-Plus machine that might favorably be made by means of the outlined method, Table I below outlines the major parameters for a wheelchair motor. This is but an example, and larger as well as much smaller machines could also be made by the method.

TABLE I
Parameters for a Possible Wheelchair Motor

| Rotor Diameter | | D = 15 cm |
|---|---|---|
| Magnet Length | | L = 20 cm |
| Clearance on outer and inner rotor circumference | | δ = 0.5 mm |
| Wire Diameter | | d = 1 mm |
| No of wires per ribbon | | N_{w} = 4 |
| Maximum current | | iₘₐₓ = 10 A |
| Thickness of rotor center sheet | | d = 1 mm |
| Wall Thickness of Double Rotor | 2T = 2w + 2t | 4 mm |
| Gap width between magnet poles | L_{G} = 2T + 2δ | 5 mm |
| Magnet width | Lₘ | Lₘ = 7.36 mm |
| Periodicity Distance | Lₚ = 2Lₘ | Lₚ = 14.7 mm |
| Flux Density due to above values | B [tesla] | ˜1.0 [T] |
| Number of zones | N_{z} = πD/Lₚ | N_{z} = 32 |
| Lorentz force per wire | F₁ = iBL | 2 [N] |
| Wires per zone (no gaps, 2rotors) | N_{wz} = 2Lₘ/w | 14.8 |
| Lorentz force per zone | N_{wz} F₁ | 29.6 N |
| Lorentz force of Machine | F = N_{wz} F₁ N_{z} | 947 N |
| Machine Torque | M_{M} = F D/2 | 71 Nm = 52 ftlb |
| Magnet height | H_{M} ˜8 mm | ˜8 mm |
| Machine Power at 60 rpm | W = M_{M}ω | 450 W˜0.6 hp |

| | |
|---|---|
| Approx weight with optimal construction | less than |
| | 10 kg = 22 lbs |
| Power density | ˜37 lbs/hp |

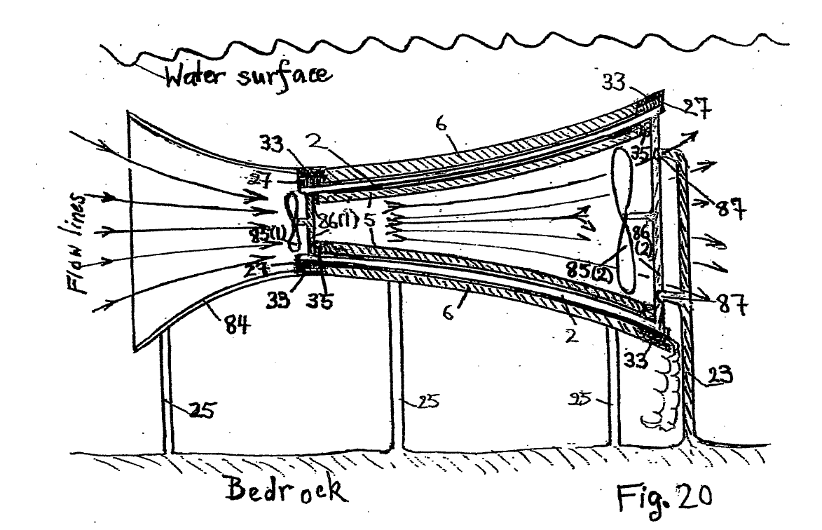

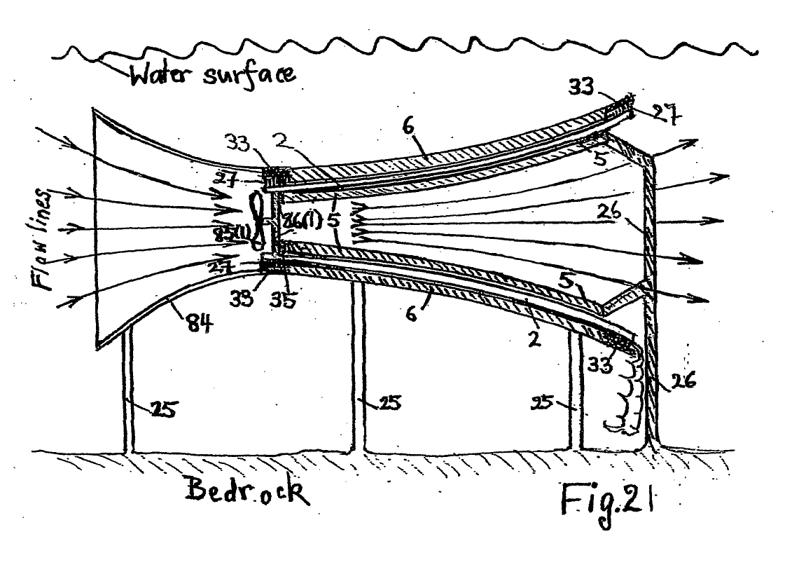

10. MP-Plus Machines with Flared Rotors and Without Axle (FIGS. 20-22)

According to the present invention, Multipolar-Plus machines may be adapted to additional uses, among others for capturing fluid flow energy or use as in-line rotary pumps, by any of the following means, alone or in combination.
(1) Rotors of general rotational symmetry, including conical, flared, barrel-shaped or other rotationally symmetrical shapes.
(2) Omitting a central axle.
(3) Mounting impellers, e.g. screws or propellers, at either or both ends of the rotor, to be inside or outside of the rotor, and/or inside the machine somewhere along the length of the rotor.

The use of conical, flaring, barrel-shaped or any other rotationally symmetrical rotors will increase the range of possible applications of the machines. For example, a fumnel-shaped or in general flared rotor will permit capturing tidal or wind energy by, say, fnineling a water flow into the narrower entrance opening generated by a conical or flared rotor, at relatively high speed, and let the water emerge at a widened exit opening with correspondingly lower speed, thereby permitting the extraction of the corresponding part of the kinetic energy of the water.

Additionally, the possibility of omitting a central axle is proposed. This is advantageous in terms of weight reduction and because it clears the interior space of MP and MP-Plus machines, which is desirable if fluid is meant to flow through them. Without an interior axle, impellers such as screws or propellers may be directly attached to the rotor rather than the machine axle. Propellers my be housed inside of the rotor, respectively the inner magnet tube, or extend outside from one or both ends of the rotor surface, if desired to relatively large radii. With large propellers or blades, the resulting geometry would be much the same with or without a central axle, and with or without generally curved rotors. Thus, with large propellers or blades, geometrically any type of multipolar machine may take the position of the hub of a propeller, and multipolar generators may be housed in nacelles of windmills.

With large propellers, MP and MP-Plus motors could be used for driving air craft or air ships, or perform the role of multipolar generators for capturing energy from fluid flows, e.g. as in windmills already mentioned or for harvesting tidal water flow energy. If propellers or screws are housed inside multipolar machines with flared rotors, they may also be used for capturing energy, e.g. in an MP-Plus generator immersed in a large ambient flow, such as in a river, or such machines may be in-line with a piped fluid flow so as to extract power from it. Alternatively, Multipolar or Multipolar-Plus machines with inside impellers may be used in the motor mode as pumps for in-line pumping of fluids.

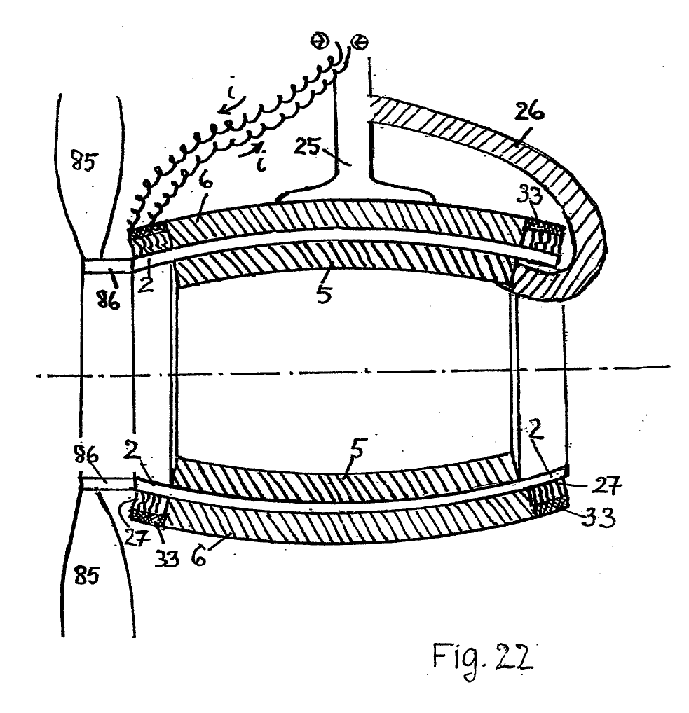

FIGS. 20 to 22 are semi-schematic cross sectional views of machines with flared (FIGS. 20 and 21) and barrel-shaped (FIG. 22) rotors. Except for items to which no label was as yet assigned, the labels in these are the same as in the other figures herein. Specifically, label 2 indicates the rotor or set of rotors; 5 is the inner magnet tube; 6 is the outer magnet tube; 23 is a mechanical support by means of which the axis of rotation is kept in place; 25 is a mechanical support for the machine that is attached to the outer magnet tube 6 and to the foundation of the machine or other large objects, e.g. bedrock in FIGS. 20 and 21, and perhaps a ships hull in FIG. 22. Further, 26 is a mechanical support of the inner magnet tube 5 that may or may not be required; 27 are the electrical brushes that guide the current to and fro between the slip rings at the two ends of the rotor of an MP machine in accordance with FIG. 1, while MP-Plus machines require only the “in” and “out” brushes shown in FIGS. 4 and 5, depending on machine construction; 33 are the brush holders for the brushes that slide on the slip rings at the ends of rotor 2 and are rigidly fastened to the two ends of the outer magnet tube 6; 35 are low-friction bearings that prevent significant displacements of the inner magnet tube in axial direction of the machine; 84 is an optional funnel extending from the outer magnet tube in FIGS. 20 and 21; 85 is a propeller; 86 is a structural support for fastening a propeller 85 to rotor 2 and rotate with it, preferably offering minimum resistance to fluid flow; 87 is a continuous groove in the otherwise lattice-like (namely to permit almost unimpeded water flow through it) support 86(2), which in FIG. 20, but not in FIG. 21, is provided with matching fingers or a continuous ring extending from support 23 so that the axis of rotating propeller 86(2) is mechanically fixed.

FIGS. 20 and 21 are meant to represent multipolar electrical generators for extracting energy from flowing water that incorporate all three of the indicated features, i.e. flared rotor, no central axle and inside propellers directly mounted to the rotor ends inside of the machine cavity, and additionally include a fiumnel 84 for directing ambient fluid flow into the generator. Conversely, variations of his configuration, i.e. without a fimnel, with and without flaring of the rotor and/or with or without a central axle but retaining the decisive feature of at least one propulsor, whether screw, propeller or other, mounted inside of the machine, could serve as a pump if the machine is driven by outside electric power.

All three constructions of FIGS. 20 to 22, envisage that propulsor(s)/propeller(s) 85, as the case may be, are rigidly connected to the rotor. Most simply they could be, optionally, mounted at the entry and/or exit end of the rotor, or both, as shown in FIGS. 20 and 21. They could also be mounted anywhere inside the machine along the length of the rotor, namely at narrow gaps between adjoining segments of the inner magnet tube 5, which is a feasible option because, except for possible sliding in axial direction, the inner magnet tube and any possible sections of it are held in place by the mutual attraction of the magnet poles in magnet tubes 5 and 6.

As already indicated, variations of a design such as in FIGS. 20 and 21 could be useful for pumping fluids in a piped system. However, if used as a generator to extract energy from an ambient fluid flow as suggested in FIGS. 20 and 21, the efficiency is liable to be rather low. Namely, under the given conditions of horizontal incompressible fluid flow, power can be extracted only from kinetic energy, namely at most as the difference between the kinetic energy with which the fluid enters and leaves the machine. Since the flow cannot leave the machine unless its pressure at least equals the ambient fluid pressure, the pressure differential driving the flow is the partial stagnation pressure derived from obstruction of the flow through the machine (ideally concentrated at the one or two propellers). In first approximation, therefore, according to Bernoulli's principle at constant gravitational height
½dv²+p=const
with d the mechanical density of the fluid, v the fluid velocity and p the fluid pressure. Further, conservation of mass requires that the flow rate in terms of mass flow per unit time, V, is constant throughout the machine i.e. that
V=v πR²=V₀
with R the local radius of the rotationally symmetrical cross sectional area of the fluid flow in the machine. Finally, at ideal efficiency, before and behind the propeller, the generated power could at most be
P=V(vᵢₙ²−vₒᵤₜ²)
Correspondingly, one would wish vₒᵤₜ to be as low as possible and vᵢₙ² to be as high as possible. However, one is constrained by the already indicated conditions that the pressure at the outflow end must exceed the ambient pressure and that a high value of vᵢₙ can only be achieved by means of throttling the flow rate, much like increasing the pressure from a garden hose by partially closing the outflow nozzle. No similar constraint exists in the use of such a design for pumping within piped fluid flows and for these, MP-Plus machines with inside propulsors could be very suitable.

The proper analysis of the discussed problem is freely available in the literature and shall not be further pursued here except for drawing the conclusion that the use of MP-Plus generators for extracting renewable energy, i.e. from wind or water, will almost certainly be more efficient and cheaper by the use of large blades, vanes, screws, propellers or other that extend far beyond the dimensions of the machine, than by the use of these inside of the machine. In such an application, flared rotors will be of limited usefilness, but generally rotationally curved rotors, specifically of barrel-shape as in FIG. 22, may be advantageous above machines with cylindrical rotors, especially if no central axle is used, e.g. as indicated in FIG. 22.

As seen, the machine in FIG. 22 incorporates a barrel-shaped rotor 2 and fitting inner and outer magnet tubes, 5 and 6. The barrel shape has the advantage that, unlike simply cylindrical rotors/magnet tubes or rotors/magnet tubes with uniformly decreasing or increasing radii, the inner magnet tube is restrained from axial displacement. Thereby the two stationary matching concentric shapes of outer and inner magnet tube, in the gap between which the rotor rotates, are fixed in position also in regard to axial displacements, and no other restraints, such as ball bearings 35 in FIGS. 20 and 21 are required. The principal disadvantage of this morphology would be cost and the difficulty of constructing it.

Again, as in FIG. 20, it is taken for granted that inner magnetic tube 5 will not rotate on account of the strong magnetic forces that act to align magnetic poles of opposite polarity across the gap within which rotor 2 rotates. This expectation is based on detailed model calculations that show that the misalignment between outer and inner magnet tubes will not rise a few degrees of arc up to the highest torques that rotor 2 can mechanically support. For the unexpected case that this conclusion fails, rotor 5 may be prevented from rotating by means of optional support 26 in both FIGS. 21 and 22.

In FIG. 22 the propeller (or blades) 85 extending from the left end of rotor 2 will rotate with the rotor, whether the machine is used as a motor, e.g. to drive a ship or an air craft, or whether the machine is used as a generator, e.g. to exploit tidal energy or is part of a windmill. In FIG. 22 the propeller is anchored to the outer side of rotor 2, but it could just as well be fastened to its inside, as in FIGS. 20 and 21, but in that case with long blades that project out of the machine and, unobstructed by a funnel 84, can have an arbitrarily larger outer radius than the outer magnet tube.

Lastly, no central axle is envisaged in FIGS. 20 to 22. Evidently, this is well possible and can save a substantial fraction of weight and a lesser of cost. Even so, the extra strength provided by an axle can be very valuable, and especially for longer machines, it may be advantageous to use a central axle for any rotor shape.

MP or MP-Plus machines need to be electrically connected, to a power source in the case of a motor, and to a consumer circuit in the case of a generator. Cables or bus bars for this purpose are indicated at lower right in FIGS. 20 and 21, and as spiral lines leading to the top left brush holder set in FIG. 22. At the top of FIG. 22, the signs of small circles with triangles in opposite directions at the electrical cables are meant to indicate that the machine is used as a motor and is driven by alternating current. In accordance with the pending patent application on MP machines, this is done by splitting an alternating or three-phase current into its positive and negative components by means of rectifiers, and applying each of these two components to one half of the “turns” but in opposite directions so that the Lorentz forces of all turns operate in the same sense of rotation.

The intrinsic simplicity of MP and MP-Plus machine construction, together with its opportunity for almost arbitrarily selecting combinations of voltages and currents by the choice of number of “turns”, as also its potentially very high power density, and being a homopolar machine with all its advantages, make it an ideal choice for transport applications, especially for ships. The choice of construction details and materials depend on cost, strength, durability, corrosion resistance and considerations of weight. For extra light weight construction one will, in the magnet tubes, use ceramic magnets embedded in plastic or composites, if not perhaps even cast into magnesium metal. Titanium or fiber composites may be used for structural parts and aluminum for the rotor. Further, brush holders will be made of plastic rather than cast metal as otherwise commonly used.

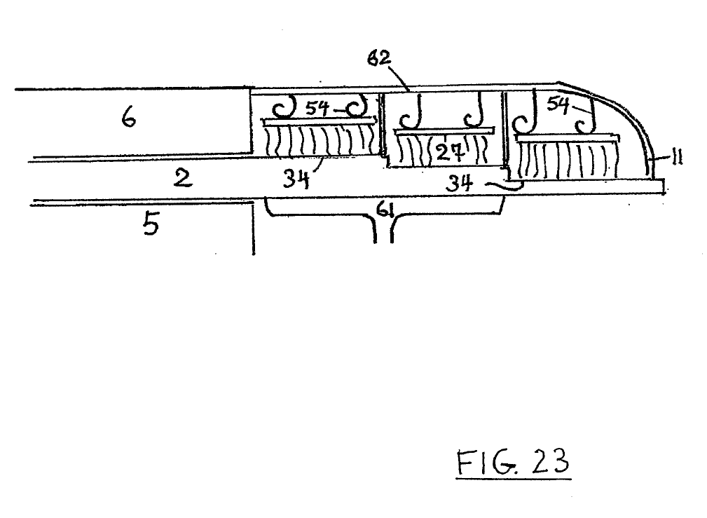

11. Enclosures about MP-Plus Slip Rings and Brushes (FIG. 23)

According to the present invention, the restricted volume occupied by electrical brushes (preferably metal fiber brushes) in MP-Plus machines, will greatly facilitate the construction of simple enclosures of the kind sketched in FIG. 23. Favorably such enclosures would be used to protect the brushes from undue ambient contamination, to provide a protective atmosphere for brushes if so desired, e.g. of moist CO₂, and/or to create a bubble of gaseous surroundings when an MP-Plus machine may operate while immersed in a liquid, e.g. when operating as a Schottel drive or podded ship drive. Such enclosures would also be possible for other MP machines, but would be especially favorable for MP-Plus machines on account of their localized brush sites which would require much less voluminous enclosures than would be needed otherwise

FIG. 23 shows a cross section of such an enclosure 62 and part of the edge of an MP-machine, including outer magnet tube 6, inner magnet tube 5, rotor set 2, connection 61 to spoke to rigidly connect rotor set 2 to the machine axle (not shown), and brushes 27, for the case of three parallel slip rings 34,—in contrast with four parallel slip rings in FIGS. 6 and 7. This arbitrary choice of number of parallel slip rings will demonstrate the general principle, while a single slip ring as in FIGS. 4 and 5 is probably the by far most common case.

In the example of FIG. 23, the enclosure is rigidly fastened to the outer magnet tube 6 and is provided with springs 54 for the application of brush pressure to brushes 27. The outer edge of the enclosure is (presumably somewhat imperfectly) sealed from the surroundings by a flexible “squeegee-type” wall (11) that slides on the outermost slip ring (34) and similar squeegee-type walls separate the parallel slip rings from each other. Such separation of the slip rings from each other will be needed in case the enclosure is partly or more filled with fluid, and specifically water, that would otherwise cause short circuiting.

In fact the brushes would need brush holders, not shown. Also not shown is a mechanism for opening and closing the enclosure. These mechanisms could be very simple, e.g. a simple plastic channel of uniform cross section to fit a somewhat thickened base plate for a brush holder, and a hinge at the outer magnet tube for opening and closing.

Fortunately, no great precautions need to be taken to prevent leaking since moisture improves the performance of most brushes, both in lowering the brush resistance and increasing wear life. Further, typically, in circumferential direction, voltage gradients along slip rings are bound to be minor. Also, a moderate amount of leaked liquid could be led off through a drain hole, not shown, and a protective atmosphere, if any, need to be maintained at only a slight overpressure. Albeit, the full voltage of a circuit will exist between the first and last brush, and these may also have to be separated by squeegee walls.

Enclosures 62 need to extend circumferentially only as far as required to envelop the brushes. With only three or four brushes side by side on any one slip ring and typically many zones per circumference, circumferential angles between the ends of an enclosure are liable to be fairly small. Given that moisture is favorable for brushes, no particular measures may be needed to control it in either direction if slip rings are immersed in water or are splashed by water outside of the enclosure.

For mirrored half circuits, two enclosures may favorably be provided for each slip ring and positioned 180° apart, in horizontal machines perhaps best in 3 pm and 9 pm positions.

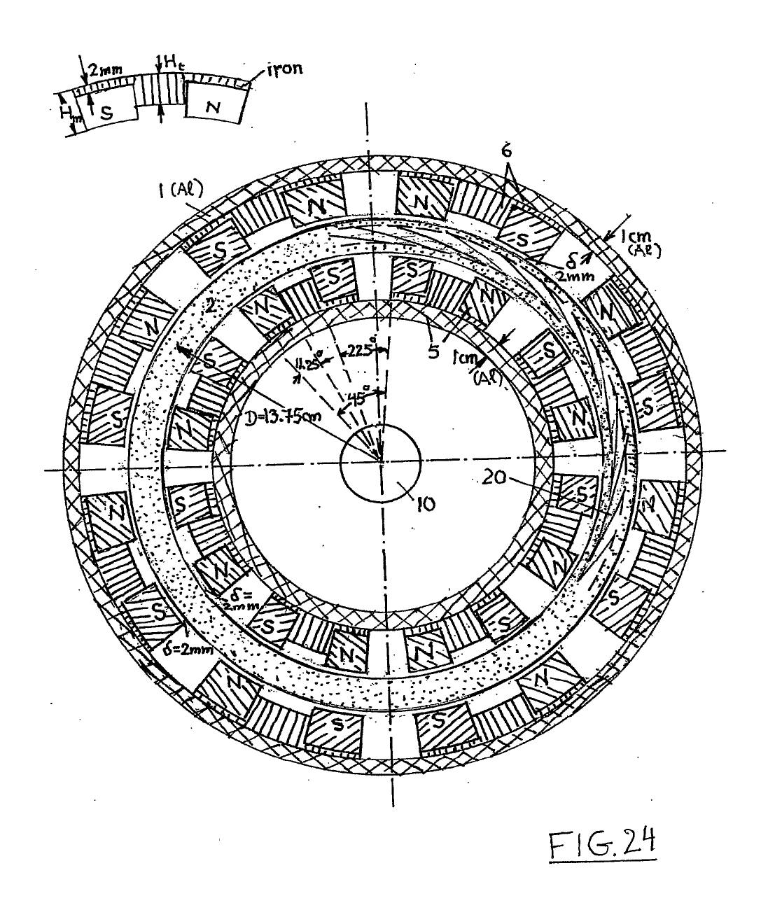

12. Small Prototype (FIG. 24)

FIG. 24 shows the cross section of a prototype MP-Plus machine, Prototype II already discussed in connection with flag construction in section 7. Its major dimensions are as follows:

| | | |
|---|---|---|
| Diameters | Rotor: | D = 13.75 cm Machine: D_{M} = 18.8 cm |
| No of rotors in set | | N_{T} = 2 (one double rotor with one insert on each end) |

| | | | |
|---|---|---|---|
| Lengths | Inner Magnet Tube: | L = 12 cm Rotor (incl. 2 slip rings): | L_{M} = 18 cm |
| Width of slip rings (each) | | Δ = 3 cm | |
| Width of magnet projection on rotor | | Lₘ = 1.35 cm | |
| No of zones (pole pairs across rotor) | | N_{Z} = πD/L_{P} = 16 | |
| Radial magnet height | | Hₘ = 1.35 cm (of which ˜2 mm is iron) | |
| Thickness of iron between magnets | | Hₜ = 1 cm | |
| Estimated flux density | | B = 0.5 tesla | |
| Wall widths | Single Rotor: | T = 3/16″ = 0.476 cm, | Rotor set: 0.952 cm |
| Wall width of outer and inner shields | | ˜1 cm (Al) | |
| Depth of grooves, width of inserts | | λ ≅ 2 cm | |
| Periodicity distance L_{P} | | L_{P} = 2Lₘ = 2.7 cm Angle subtended on rotor: 45° | |
| Machine volume | | ν = (π/4) D_{M}²L_{M} = 5 liter = 0.18 ft³ | |

Weights magnets/iron: mₘ ≅7.8 kg = 17 lbs; rotor: mᵣ = 6.6 kg = 15 lbs; m_{M} ˜1.3(mₘ + mᵣ)˜40 lbs

As seen from the arrangement of its magnets, Prototype II is of the mirrored half circuit construction with two slip rings, one at each rotor end. The machine was made by a skilled instrument maker and appears to perform according to expectation but has not yet been tested.

Initial plans had been to make flags by the groove and insert method but this was beset with difficulties that are not believed to be insurmountable. Therefore the simpler method of flags between tabs inserted between every neighboring pair of rods was adopted.

With the use of graphite brushes of =4 cm² area each, a current of i_{M}=240 is expected to be attainable, and with the use of metal fiber brushes i_{M}=800 A. At a brush sliding speed of vᵣ=25 m/sec (which is near the top speed for monolithic brushes and would occur at ˜3500 rpm), and with B=0.5 Tesla assumed, the correlated machine voltage will be V_{M}=N_{Z}LBvᵣ=24V to yield W_{M}=6000 w=7.7 hp machine power with graphite brushes, and at i_{M}=800 A with metal fiber brushes will yield 800 A×24V=19.2 kW=25.6 hp. Further, the projected machine weight of about 40 lbs was found to be satisfyingly near the actual prototype weight. This will yield the astonishingly high power density of W_{M}/m_{M} ˜40 lbs/25.5 hp=1.6 lbs/hp. This is to be compared with the best value found for large machines in the literature, namely 3.1 lbs/hp for the superconducting 50,000 hp motor currently under construction by American Superconductors, bearing in mind, also, that the weight to power ratio tends to drop with increasing machine size.

### LIST OF REFERENCES

1. D. Kuhllmann-Wilsdorf, “Bipolar Machines—A New Class of Homopolar Motor Generator”, Patent Application, filed May 7, 2002.

What is claimed as new and desired to be secured by letters patent of the United States is:

1. A homopolar machine capable of operating as an electric motor, an electric generator, an electric transformer, and/or an electric heater, comprising:
multiple magnetic field sources surrounding a current channeling, rotatable rotor set of N_{T}≧2 rotors;
said rotor set having a rotor wall of substantially constant thickness; and
said magnetic field sources establishing a magnetic flux density B in a multiplicity of axially extended zones in said rotor wall; and
said magnetic flux density B alternating in radial orientation between neighboring zones; and
said rotor wall comprising a multiplicity of permanent internal connections conductively connecting correlated positions in neighboring zones of neighboring rotors, and
said internal connections are arranged so as to establish a multiplicity of mutually insulated current paths.

2. A homopolar motor comprising:
multiple magnetic field sources surrounding a current channeling, rotatable rotor set of N_{T}≧2 rotors;
said rotor set having a rotor wall of constant thickness; and
said magnetic field sources establishing a magnetic flux density B in a multiplicity of axially extended zones in said rotor wall; and
said magnetic flux density B alternating in radial orientation between neighboring zones; and
said rotor wall comprising a multiplicity of permanent internal connections conductively connecting correlated positions in neighboring zones of neighboring rotors, and
said internal connections are arranged so as to establish a multiplicity of mutually insulated current paths.

3. A homopolar generator comprising:
multiple magnetic field sources surrounding a current channeling, rotatable rotor set of N_{T}≧2 rotors;
said rotor set having a rotor wall of constant thickness; and
said magnetic field sources establishing a magnetic flux density B in a multiplicity of axially extended zones in said rotor wall; and
said magnetic flux density B alternating in radial orientation between neighboring zones; and
said rotor wall comprising a multiplicity of permanent internal connections conductively connecting correlated positions in neighboring zones of neighboring rotors, and
said internal connections are arranged so as to establish a multiplicity of mutually insulated current paths.

4. A homopolar transformer comprising:
multiple magnetic field sources surrounding a current channeling, rotatable rotor set of N_{T}≧2 rotors;
said rotor set having a rotor wall of constant thickness; and
said magnetic field sources establishing a magnetic flux density B in a multiplicity of axially extended zones in said rotor wall; and
said magnetic flux density B alternating in radial orientation between neighboring zones; and
said rotor wall comprising a multiplicity of permanent internal connections conductively connecting correlated positions in neighboring zones of neighboring rotors, which conductive internal connections are dubbed flags; and
which flags are arranged so as to establish a multiplicity of mutually insulated current paths.

5. A homopolar machine according to claims 1, 2, 3 or 4 wherein a plurality of said magnetic field sources are configured into at least one of an outer and an inner magnet tube.

6. A homopolar machine according to claim 5 operating as a motor.

7. A homopolar machine according to claim 5 operating as a generator.

8. A homopolar machine according to claim 5 operating as a transformer.

9. A homopolar machine according to claim 5 simultaneously operating as two or more of a selection of a motor, a generator, a transformer and a heater.

10. A homopolar machine according to claim 5 wherein said magnetic field sources are magnets that pair-wise face each other across the wall of said at least one rotatable rotor set

11. A homopolar machine according to claim 5 wherein said magnet tubes comprise a selection of at least one permanent magnet, at least one electromagnet or at least one superconducting magnet.

12. A homopolar machine according to claims 1, 2, 3, 4 or 5 wherein said mutually insulated current paths form a radial zig-zag between a pair of adjoining zones through the thickness of the wall of said rotor set.

13. A homopolar machine according to claim 5 wherein said magnetic field sources comprise a multiplicity of permanent magnets with triangular cross sections.

14. A homopolar machine according to claim 5 wherein said magnetic field sources comprise a multiplicity of permanent magnets with pyramidal cross sections.

15. A homopolar machine according to claim 5 wherein said magnetic field sources comprise a multiplicity of magnets with pair-wise pyramidal cross sections.

16. A homopolar machine according to claim 5 wherein said magnetic field sources comprise a multiplicity of permanent magnets which are composed of a permanent magnet material and a magnetically soft ferro-magnetic material.

17. A homopolar machine according to claim 5 wherein said magnetic field sources comprise a multiplicity or pairs of magnets of same polarity side by side so as to form a zone of enlarged width.

18. A homopolar machine according to claim 5 wherein said rotor set has general rotational symmetry.

19. A homopolar machine according to claim 18 wherein said rotational symmetry is one of cylindrical, conical, flared or barrel-shaped.

20. A multipolar machine according to claims 18 or 19 without a central axle.

21. A homopolar machine according to claims 18 or 19 comprising at least one of an impeller, propeller, flywheel, screw, propeller or drive shaft directly attached to at least one end of said rotor.

22. A homopolar machine according to claim 5 comprising at least one N_{T}=2 rotor set made through wire winding.

23. A homopolar machine according to claim 5 wherein the magnetic field sources of the outer magnet tube are N, S, N, S, etc. around its circumference and in which the magnetic field sources of the inner magnet tube face those of the outer magnet tube in an arrangement of S, N, S, N, etc. around its circumference.

24. A homopolar machine according to claim 23 except that at one position on the outer magnet tube two N or two S poles are side by side and that face two S or two N poles on the inner magnet tube.

25. A homopolar machine according to claim 23 except that at two diametrically opposite positions on the outer magnet tube two N or two S poles are side by side and that face two S or two N poles on the inner magnet tube.

26. A homopolar machine according to claim 24 wherein the internal connections are arranged to define circumferential zig-zags between concentric rotors.

27. A homopolar machine according to claim 25 wherein the internal connections are arranged to define circumferential zig-zags between concentric rotors.

28. A homopolar machine according to claim 23 wherein the internal connections are arranged to define radial zig-zags between the outermost and innermost rotor.

29. A homopolar machine according to claim 24 fuirther comprising at least one brush contacting a rotor only at the N, N zone and facing S, S zone.

30. A homopolar machine according to claim 25 firther comprising at least one brush contacting a rotor at both the N, N zones and at least one other brush contacting a rotor at both the facing S, S zones.

31. A homopolar machine according to claims 23, 24, 25, 26, 27 or 28 wherein the rotor set comprises N_{T}=2 rotors.

32. A homopolar machine according to claim 23, 24, 25, 26, 27 or28 wherein the rotor set comprises a multiplicity of N_{T}≧4 rotors in concentric arrangement.

33. A homopolar machine according to claim 5 comprising compacted R-units of shaped metal sheet or metal foil.

34. A homopolar machine according to claim 33 comprising compacted R-modules made of compacted R-units.
